(19) United States
(12) Patent Application Publication
(10) Pub. No.: US 2004/0162741 A1
(43) Pub. Date: Aug. 19, 2004

(54) Method and apparatus for product lifecycle management in a distributed environment enabled by dynamic business process composition and execution by rule inference

(76) Inventors: David Flaxer, Dobbs Ferry, NY (US); Henry Chang, Scarsdale, NY (US); Hui Lei, Scarsdale, NY (US); Liang-Jie Zhang, Cortlandt Manor, NY (US); Jun-Jang Jeng, Armonk, NY (US); Liangzhao Zeng, Sydney (AU)

Correspondence Address: Whitham, Curtis & Christofferson, P.C., Suite 340, 11491 Sunset Hills Road, Reston, VA, 20190, US

(21) Appl. No.: 10/359,732

(22) Filed: Feb. 7, 2003

(51) Int. Cl. G06F 17/60

(52) U.S. Cl. 705/7

(57) ABSTRACT

A system and method for supporting Product Lifecycle Management over a distributed service network topology that connects a hierarchy of functional domains, each domain having a service ontology and one or more service composition schemas defined by the service ontology. Each service composition schema models a business process in its domain. Descriptions of services provided to each domain are published to a service repository by providers of the services, in conformity with one of the service composition schemas. There is a business process proxy provided by the service provider for each service description, which encapsulates for public access the internal processes of the service provider. The invention makes use of an event messaging protocol that enables service collaboration and ad-hoc workflow composition. Each business process is implemented by an ad-hoc workflow comprised of one or more tasks connected by one or more business rules. For each business process there is a business flow manager that dynamically composes ad-hoc workflow prior to execution and dynamically modifies the ad-hoc workflow as the business process executes. The business flow manager uses backward-chain inferencing and then forward-chain inferencing to generate the ad-hoc workflows, based on user identification of a target task. The business flow manager is able to stop execution of the workflow and regenerate a workflow for remaining tasks in response to events received over the network from service providers, and is also able to detect conflicts in the workflows at composition time and at execution time.

### BACKGROUND OF THE INVENTION

1. Field of the Invention

The present invention generally relates to systems and methods for adapting workflow management to rapidly changing business environments, and more particularly to product lifecycle management of projects composed of services provided in distributed environments such as the Internet.

2. Background Description

Product Lifecycle Management (PLM) is software, services, and consulting to help companies manage and integrate product information and business interaction across a wide range of business processes. PLM technology manages and supports complex tasks throughout a products lifecycle, from cradle to grave. This includes phases such as: product conception (marketing and business analysis); product development (engineering and other product development tasks); production and distribution (enterprise resource planning and supply chain management); and customer service and support (customer relationship management). Examples of PLM applications are wide ranging and include the aircraft, automobile, machinery and electronic industries, whose employees use advanced collaboration and system and business integration technologies.

Business integration and collaboration is applicable to all phases of the PLM process but it is particularly challenging during the product design and development phase, where unrestrained user-directed initiatives meet a boundary of business constraints established under inter/intra enterprise integration. The key challenge is to provide PLM tools and technology that aid the user in conducting ad-hoc activities while introducing an orderly set of process and organization around their work in such a way as to promote creative activities, thus liberating users from the burden of managing the details of process and integration within a larger business context.

The realization of the technology for PLM is in part a transformation of the established Business-to-Business paradigm and enabling infrastructure into a general framework supporting dynamic ad-hoc activities. Critical to this effort is the dynamic generation and control of ad-hoc processes—the composition of steps or tasks involved in achieving a goal through conception, execution and termination. The aggregation of steps that comprise a business process, from the start to a completion of a goal, is represented by a workflow. The challenge with ad-hoc processes is that the specific workflow path that comprises the end-to-end process cannot be scripted or predicted in advance. The enabling of ad-hoc processes is founded on dynamic support: intelligent analysis and recommendation of processes known to yield best results based on the context of the specific project; the management and monitoring of these processes as each step progresses; and reevaluation of decisions as the workflow process transpires. Further, since each process step (also referred to as a task) involves the employment of a service, a means by which the service provider can declare, integrate and coordinate their service processes (called microflow) within the running of an ad-hoc process is critical to the dynamic construction of the overall workflow. Thus ad-hoc workflow is realized through dynamic composition and re-composition of services ongoing throughout workflow execution.

Increasingly, enterprises are adopting a service outsourcing model where projects and products are disaggregated and contracted to service providers operating within a distributed computing environment. These environments include Internet hubs or private networks, which enable the establishment of faster and more effective collaboration with service partners. Managing business processes in a distributed network places challenges on business controls, business process software and IT infrastructure.

Currently, most PLM solutions are implemented in a centralized and static architecture. A central organization forms a long term relationship with is its partners in a tightly coupled mode to interact through well established and scripted PLM workflow process. Not only is the data stored in the central organization, but also the business transitions are programmed to operate within the central enterprise. Developing PLM solutions in this environment is time-consuming and requires enormous efforts of low-level programming. A centralized PLM architecture is difficult to scale. Moreover, this architecture cannot provide the flexibility required to support PLM processes that are highly dynamic and ad-hoc. The challenge of supporting PLM processes is to provide a facility allowing enterprises to dynamically integrate business processes to support their PLM processes, independent of platforms, location, and systems.

A critical technical requirement in support of PLM is to enable a dynamic business process composition mechanism and a workflow engine to execute the process. In the last few years workflow management has increasingly gained relevance as the technology of choice for business process reengineering, e-commerce and business-to-business integration. As a result, many enterprises and organizations have moved towards the automation of their business processes using Workflow Management Systems (WFMSs). One of the fundamental assumptions in current WFMS is that workflow schemas (i.e. tasks, control flow and data flow) are predefined. In order to automate business processes workflow designers need to understand business processes and use workflow modeling tools to define workflow schemas. When an end user wants to execute a business process, they create a workflow instance by selecting a workflow schema and providing the necessary input data. WFMS executes the workflow instance and returns the results to the end user.

One of the most significant weaknesses of predefined workflow schemas is their lack of flexible mechanisms to adequately cope with ever-changing environments. Modification of business processes is necessary to meet changes in application requirements, technology, policies, and organization. However, such modification procedures are time consuming and costly. Moreover, enterprises are changing constantly: entering into new markets, introducing new products and fine-tuning themselves through mergers, acquisitions, alliances and divestitures. Consequently, predefined workflow schemas may become increasingly impracticable for many enterprises.

There are many on going research efforts in the workflow management area. Business rules are used in several research projects. In the WIDE project, as described by Stefano Ceri, Paul W. P. J. Grefen, and Gabriel Sanchez in “WIDE: A distributed architecture for workflow management”, 7th International Workshop on Research Issues in Data Engineering (RIDE '97), High Performance Database Management for Large-Scale Applications, Apr. 07-08, 1997, Pages 76-82, Birmingham,UK, a workflow management system is built to support distributed workflow execution. Event-Condition-Action (ECA) rules are used to support exceptions and asynchronous behavior during the execution of workflow. In the EvE project, as described by Andreas Geppert and Dimitrios Tombros in “Event-based distributed workflow execution with EVE”, Proceedings IFIP International Conference on Distributed System Platforms and Open Distributed Processing Middleware '98. Springer, 1998, ECA rules are used to address the problem of distributed event-based workflow execution, which is a fundamental metaphor for defining and enforcing workflow logic. Both WIDE and EvE are static predefined workflow schemas using the ECA rules. There is a need for an approach that uses business rules to dynamically infer workflow schemas.

Dynamic workflow management systems focus on the evolution of business processes by adapting to business changes. ADEPTFLEX, as described by Manfred Reichert and Peter Dadam in “ADEPT flex: supporting dynamic changes of workflows without losing control,” Journal of Intelligent Information Systems, 10(2): pp. 93-129, 1998, presents a formal foundation for the support of dynamic structural change of running workflow instances. Based upon a formal workflow model, a complete and minimal set of change operations are defined to support users in modifying the structure of a running workflow instance, while maintaining correctness and consistency of workflow. METUFlow2, as described by Pinar Koksal, Ibrahim Cingil, and Asuman Dogac in “A component-based workflow system with dynamic modifications,” Next Generation Information Technologies and Systems, pp. 238-255, 1999, is a component-based workflow system that is specially designed for adapting the business process changes in its environment. With it, users can initiate dynamic modification of a workflow instance during execution. The present invention differs from these existing works in its ability to dynamically predict and modify workflow based on business rules and rule inference.

Decision Flow, as described by Richard Hull, Francois Llirbat, Jianwen Su, Guozhu Dong, Bharat Kumar, and Gang Zhou in “Efficient support for decision flows in e-commerce applications” in Proceeding of 2nd Intl. Conf. on Telecommunications and Electronic Commerce (ICTEC), 1999, focuses on providing a high level business process specification language with declarative semantics, which can be understood by users throughout an enterprise. It provides an algorithm for eager detection of eligible, unneeded or necessary tasks to support efficient execution of decision flow. However, the decision flow is predefined and the business rules are statically bound into the decision flow. Internet-based Scalable E-business Enterprise], as described by J. Meng, S. Y. W. Su, H. Lam, and A. Helal in “Achieving dynamic inter-organizational workflow management by integrating business processes, events, and rules” in Proceedings of the Thirty-Fifth Hawaii International Conference on System Sciences (HICSS-35), 2002, introduces events and rules into the business process, which enables runtime modifications; however, the business processes are predefined and events and rules are static bound. Different from Decision Flow and ISEE, the present invention provides a method that composes the business processes dynamically prior to execution and continues evaluation of the workflow as events occur during execution, during which time business rules are dynamically bound to the workflow.

### SUMMARY OF THE INVENTION

It is therefore an objective of the present invention to support the requirements of Product Lifecycle Management such as those found in product design scenarios, where work is performed by collaborative partners and service providers that exist within heterogeneous distributed environments such as the Internet.

A further and critical objective of the present invention to support the requirements of ad-hoc workflow such as those found in PLM, where decisions made by collaborative partners necessitate the dynamic composition and modification of running workflows.

An object of the invention is to provide a task oriented workflow development and execution system where decision flows may be defined or modified during execution.

Another object of the invention is to allow business rules to be changed during execution and to provide for automatic generation of new or revised decision flows consequent upon business rule changes.

It is also an object of the invention to provide for evaluation of the workflow as events occur during execution and to regenerate decision flows from business rules in response to events.

A further object of the invention is to compose business processes dynamically prior to execution so that events and rules may be modified during execution.

It is another object of the invention to provide a rule inference engine for generating workflow schemas and tasks from rules.

Yet another object of the invention is to provide rules which may be rapidly defined and modified in response to changing business conditions.

This invention provides an innovative and novel framework for supporting the PLM process, in particular, during the design phase, whose critical problems are: ad-hoc workflow, service composition, collaboration, business integration, process automation and execution. This solution, dedicated to the PLM domain, is aptly named “PLM-web”. PLM-web is a distributed interconnection of process flow managers (supervisors of dynamic workflow processes) and service providers that subscribe to an implementation of unique service ontology models, service composition schema models, and event messages models. These models enable a common understanding of services and their interfaces, and facilitate event messaging, execution control and data exchange among process managers and service providers. To support ad-hoc workflow, process flow managers implements dynamic business process composition and execution using business rules, without the aid of any predefined workflow schemas. This is accomplished by the adoption of a business rule inferencing framework that employs backward and forward rule chaining techniques coupled with applied algorithms and logic. The PLM-web is essentially a network topology of flow managers, service providers and other functions that support a dynamic and virtual enterprise dedicated to supporting PLM objectives.

This invention further describes the functional elements that comprise PLM-web, a novel framework whose objective is to support the requirements of dynamic and ad-hoc processes of product development and design. PLM-web is composed of a customized assemblage of technologies that includes rules engines, workflow managers, business integration adaptors and web services that implement a unique set of service ontologies, event messages, workflow inferencing models and logic algorithms. Taken as a whole, these form a new method for supporting Product Lifecycle Management enabled by service collaboration, for which we are applying for patent. The salient features of PLM-web are:

A distributed service network topology that interconnects process flow managers, services providers, and other support functions, organized to supporting PLM objectives.

Automated business-to-business integration, collaboration and coordination within the distributed PLM network enabled by workflow technology and business rules.

A process flow manager, uniquely dedicated to supporting PLM requirements for ad-hoc workflow, which enables service composition and execution, dynamically monitoring and modifying such workflow as processes execute.

A business process proxy uniquely dedicated to the PLM-web that encapsulates internal process of service providers, and specifies a higher-level interface, accessible to PLM service requesters that enable the service ontology it supports.

A unique service ontology schemas, dedicated to the PLM-web, that models the terminologies and functions applicable to service providers. This includes specifications for service composition and service description schema that describes such things as the workflow state machine, SLA, invocation information and other characteristics of a service that a service requester needs to understand in order to use it.

A set of service repositories, dedicated to the PLM-web, which enables a central directory source for service ontology, service descriptions and service composition schema.

The motivation of the PLM-web is to provide a service-oriented framework that supports distributed Business-to-Business integration and collaboration dedicated to supporting the requirements of Product Lifecycle Management. In this environment vendors (i.e. service providers) sell their business processes (i.e. services) to manufacturing and other enterprises (i.e. service requesters). In this distributed environment the relationships between service requesters and service providers are transient and are loosely coupled. Services form fast and short term partnerships and then these partnerships disband when the PLM process is completed. In the PLM-web, the system does not assume an a priori defined business process schema; instead, in order to support the PLM process, the system dynamically composes business process schemas, then selects and invokes the service provider.

In this invention a network-based architecture is employed to support PLM. The following are key advantages that distinguish PLM support as a network based architecture:

In network-based environments, the service space is very large and highly dynamic. How to describe and discover such services is an enormously complex effort and may be solved using technologies such as Web services. Web services are Internet-based, modular applications that provide standard interfaces and communication protocols for efficient and effective business application integration. Typical application areas are business-to-business integration, business process integration and management, content management, e-sourcing, and design collaboration for engineering, scientific and business endeavors.

Given the highly dynamic and distributed nature of the PLM process, a distributed network facilitates PLM scalability, availability, flexibility and security.

PLM processes require the establishment of dynamic Business-to-Business integration and coordination. In this, there are two aspects. (1) The PLM process itself is dynamic and the schema changes frequently, thus, it is impractical to predefine them at the build time. (2) The second aspect is related to service invocation during the execution of PLM processes. Since the new services are dynamically added, removed and modified into the system frequently, the PLM process may use different services to implement similar PLM process instances (i.e. workflows). Network architecture enables a more flexible environment to recognize the dynamic nature of services and service providers.

Most PLM processes are long running business transitions. It is necessary for PLM processes to adapt the changes that occur during its execution. In a distributed network it is easier for the system to monitor the processes, and to detect and adapt to changes.

A unique event messaging model and specification is provided, dedicated to the PLM-web, that enables service collaboration, ad-hoc workflow composition, execution and monitoring.

The present invention provides a solution to the above-described problems by dynamically creating workflow schemas that describes the ad-hoc business process. By “dynamic” is meant that the schemas are created and recreated from elements that may be changed during execution. This is achieved through using business rules and rule inference. Business rules are statements about how the business is conducted, i.e., the guidelines and restrictions with respect to business processes in an enterprise. The business rules should be independent of individual business processes. This is different from traditional WFMSs where the business rules are implicitly embodied in the predefined workflow schemas. When business rules are separated from particular businesses processes, any changes in business logic can be captured through modification of business rules and dynamic deployment to business processes. A business rule based framework is an agile solution that provides the flexibility to adapt to business changes. This framework supports ad-hoc workflow, which dynamically constructs workflow instances without any predefined workflow schemas. In this framework, execution of workflow is realized by service composition and coordination. It is assumed that services are distributed over a private or public network. Based on an end user request, the system dynamically creates workflow schemas by rule inference. Using the business rules during execution, the system incrementally modifies the workflow, selects service providers for execution of tasks, or coordinates task execution.

This invention uses a novel framework call “PLM-flow” that enables business process composition and execution by business rules inference. The salient features of PLM-flow are:

Exploitation of a business rule inferencing framework that supports the generation of ad-hoc workflow through dynamic service composition by rule inference, and supports detection and resolution of workflow conflicts during execution. This includes use of a unique set of rule template specifications, that models business logic through business rules, and supports pertinent aspects of business processes including: authorization, schema, service provider selection, execution, coordination and data source.

A set of business rule templates for modeling business logic. We define a set of rule templates that cover all aspects of business logic in business processes.

An ad-hoc workflow composition engine that creates workflow schemas through a combination of backward-chain inference and forward chain inference. Use of this workflow composition engine allows end users to focus on their business goals instead of having to provide detailed control and data flows. The workflow engine is also able to detect and resolve conflicts among business rules.

The invention provides a system and method for supporting Product Lifecycle Management over a distributed service network topology. The topology connects a hierarchy of functional domains, each domain having a service ontology and one or more service composition schemas defined by the service ontology. Each service composition schema models a business process in its domain. Descriptions of services provided to each domain are published to a service repository by providers of the services, in conformity with one of the service composition schemas. There is a business process proxy provided by the service provider for each service description, which encapsulates for public access the internal processes of the service provider. The invention makes use of an event messaging protocol that enables service collaboration and ad-hoc workflow composition. Each business process is implemented by an ad-hoc workflow comprised of one or more tasks connected by one or more business rules. Service providers for tasks are identified from information in the service repository. For each business process there is a business flow manager that dynamically modifies the ad-hoc workflow as the business process executes. The business flow manager uses a business rule inferencing framework to generate the ad-hoc workflows, based on user identification of a target task. The business flow manager is able to stop execution of the workflow and regenerate a workflow for remaining tasks in response to events received over the network from service providers and in response to conflicts detected in the workflow.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagram showing a conceptual model of the PLM Web.

FIG. 2 is a chart of a service ontology.

FIG. 3 is a chart of a state machine for a service composition schema.

FIG. 4 is a chart of a service description.

FIG. 5 is a flow diagram showing the running state of a task.

FIG. 6 is a flow diagram showing the state of data.

FIG. 7A illustrates a task microflow and events corresponding to task states. FIG. 7B shows an event table for a service requester.

FIG. 8 is schematic showing tasks in PLM-flow.

FIG. 9 is a flow chart showing business process composition and execution in PLM-flow.

FIG. 10 is cyclic graph showing forward and backward chaining relationships between tasks.

FIG. 11 is a flow chart of backward chain inference.

FIG. 12 shows a condition tree.

FIG. 13 is a flow chart of forward chain inference.

FIG. 14 shows a condition tree with annotations.

FIG. 15 is an example of multiple workflow schemas generated for a single rule set.

FIG. 16A is a diagrammatic illustration of adding tasks to workflow schemas. FIG. 16B is a diagrammatic illustration of adding a transition to a workflow schema. FIG. 16C is a diagrammatic illustration of deleting a transition from a workflow schema.

FIG. 17A is a diagrammatic illustration of migrating a workflow schema while the workflow executes.

FIG. 17B is a diagrammatic illustration of rules and dynamic control of workflow.

FIG. 18 is a schematic of the basic PLM system architecture.

FIG. 19 is a schematic of the architecture of a PLM-flow manager

FIG. 20 is a schematic showing a public provider interface.

FIG. 21 is a schematic of showing a business process proxy for a service provider.

FIG. 22 shows a schematic of a Virtual PLM-web.

FIG. 23 is a schematic of a hub implementation model of PLM-web.

FIG. 24 is a schematic example of a rule-based workflow process.

FIG. 25 shows an example of a basic composed workflow process.

FIG. 26 is a flow chart showing how the workflow of FIG. 25 was executed.

FIG. 27 is a message communication timeline showing workflow process messaging for the workflow described in FIGS. 25 and 26.

FIG. 28 is a screen image of a workflow interface in a system implementing the invention.

FIG. 29 is diagram showing a business process proxy enabled on a service provider.

FIG. 30 is a diagram showing execution flow for a PLM process.

FIG. 31 is a flow chart showing run-time regeneration of workflow schema.

### DETAILED DESCRIPTION OF A PREFERRED EMBODIMENT OF THE INVENTION

In this invention we describe PLM-web, a novel framework that supports distributed interconnection for process and business integration between service requesters (in the form of PLM-flow managers, which act on the users' intentions) and service providers. Based on user's request, the system uses business rules to dynamically compose business process and select service providers to execute the tasks in the business processes. During execution time the system incrementally reevaluates the business process, modifies service compositions, selects service providers for tasks, modifies the running services, or coordinates the execution of tasks. Both PLM-flow managers and service providers are distributed across and are interconnected throughout the PLM-web.

The invention is built upon a sequence of models, which when aggregated together, comprise a unique framework that supports PLM requirements for ad-hoc workflow and distributed service collaboration. These models are organized as follows:

Section 1: Presents a Service Ontology Model that describes fundamental concepts on service ontology, service compositions schemas and service descriptions

Section 2: Presents the Event Model that enables message interaction between service managers and service providers

Section 3: Discusses Business Rule Model, including rule templates and also provides some background on use of rule inferencing engines

Section 4: Presents a System Architecture Model outlining a network topology, functional components and preferred embodiment.

### 1.0 Service Ontology Model

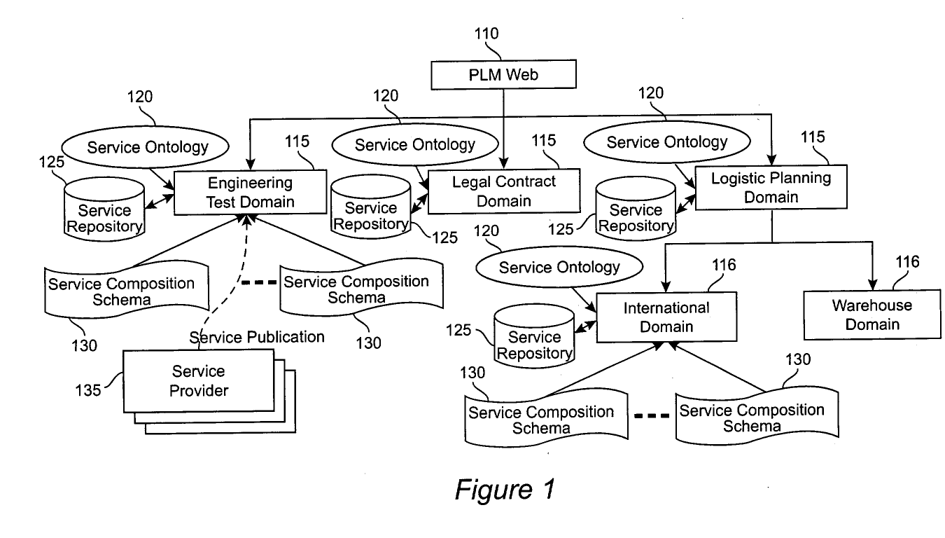

The invention provides a framework for the composition, management, and evolution of distributed business processes. The underlying paradigm relies on dynamic composition of localized business processes into enterprise wide business processes based on business rules. The invention uses a service ontology to model basic concepts, terminologies and functionality in different functional domains. As shown in the example in FIG. 1, there is a hierarchy of functional domains in the system: each non-root node 115 and 116 represents a functional domain while the root 110 represents the whole system. In each domain, there is a service ontology 120 and a set of service composition schemas 130 that model business processes (i.e. composite services) in the domain. It is noted that service ontologies 120 are used to define service composition schemas 130, service description, etc. In the following subsection, these concepts are presented in detail.

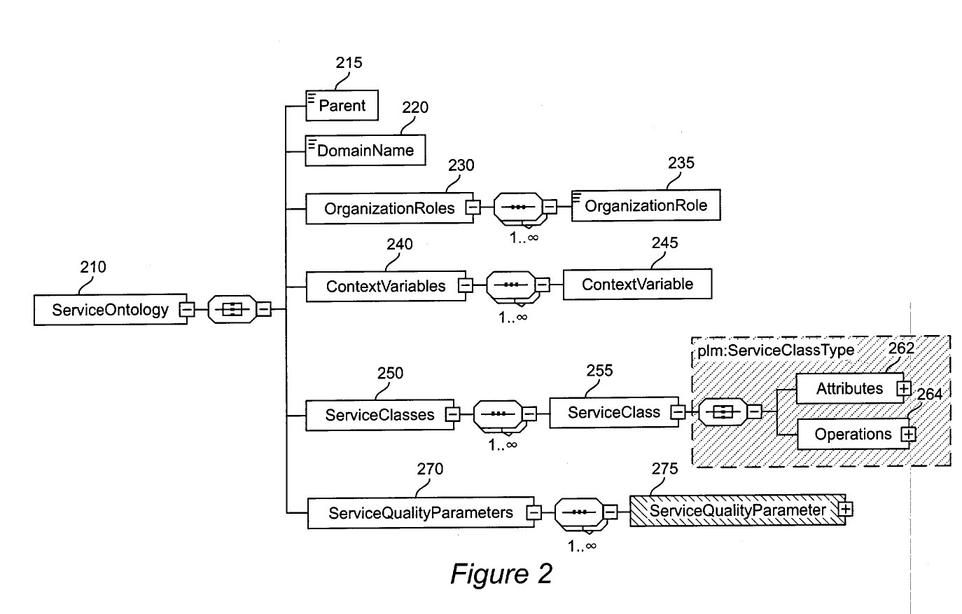

Service ontology 120 defines basic concepts and terminologies that are used inside the domain. Service ontologies are organized in a hierarchy as shown in FIG. 2. The child node inherits the properties of the parent node. There is shown in FIG. 2 a pointer 215 to the parent node. A service ontology has the following components: a domain name 220, a set of organization roles 230, a set of context variables 240, a set of services classes 250, and a set of service quality parameters which specify criteria 270.

The domain name 220 gives name of the domain. For example, a domain name can be engineering testing (as shown in FIG. 1). An organization role 235 is defined as a placeholder for participating business processes. Each role 235 must belong to a domain 115. For example, in engineer-testing domain, the roles may include testing engineer, etc. Context variables 240 define the basic terminologies in the domain. As an example, engineer-testing domain contains context variables such as metal fatigue index, etc. A context variable 245 is defined by name and data type.

Service classes 250 provide the information about the basic functionality in a domain. These service classes are used to construct more complex business processes. A service class 255 is defined by a set of attributes 262 and operations 264. An operation is further defined by operation name, input and output data type. For example, in the ontology “Tourism”, the service classes might include Flight Ticket Booking, Accommodation, Car rentals, etc. In service class Flight Ticket Booking, the operations may include bookingTicket, changeTicket, etc. It is noted that service providers 135 use the service classes 250 to define primitive services as operations.

There are two types of service quality criteria 270, namely generic quality criteria (i.e. are used by all domains) and domain specific criteria. Each criterion has a name, type and unit. For each criterion 275 there is also a definition of how to measure or compute the value. Example service quality criteria are: execution cost, execution time, availability, reliability and reputation.

Service composition schemas 130 model business processes that consist of a set of services. A composite service can involve services provided by different domains; however, each domain manages their own service composition schema. Service composition schemas are defined within a state machine that uses the context variables 240 and service classes 250 defined in a service ontology 120 to which the domain subscribes.

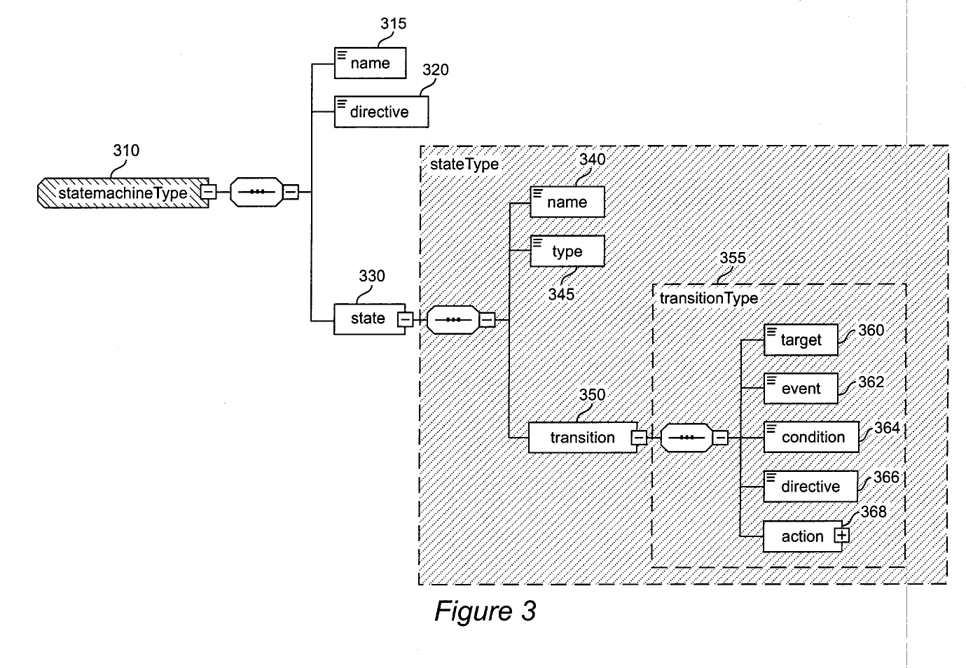

Referring to FIG. 3, a state machine 310 consists of the list of states 330 that are named 340 and also identified based on their type 345 (e.g. normal, terminal, etc.), and the permissible transitions 350 between these states where each transition 355 is specified from a given state to a target state 360. There can be many transitions from any given state. In a state machine, state transitions 350 are triggered for defined events 362 when a given condition expression 364 on the transition 355 is satisfied. When a state transition occurs, an action 368 is executed. The actions are referred to primitive services (i.e. the operations 264 in a service ontology 210). The data flow in a state machine isn't explicitly defined. However, there is a data pool for each state machine to contain all the input and output data. Directive 320 contains data or control specifications that affect the behavior of state machine 310; Directive 366 contains data or control specifications that affect the behavior of transition 350.

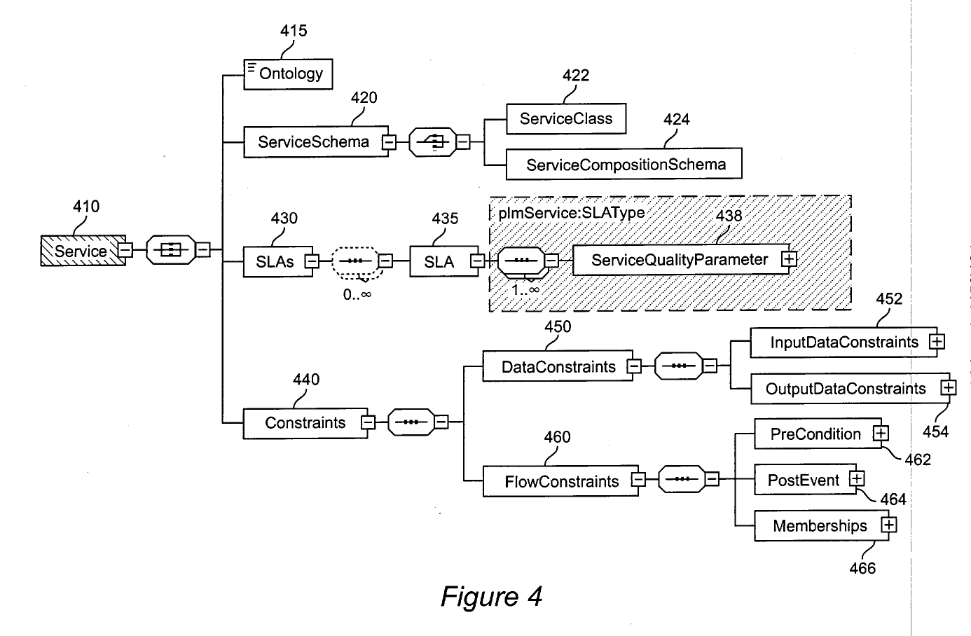

In order to participate in the system, service providers 135 need to publish their service descriptions to the service repository 125. There are two types of services: primitive services and composite services. Primitive services are instances of services classes 250 in a service ontology 210, while composite services are instances of service composition schemas 130. It is noted that what service providers publish are public processes. According to public processes, service providers have their own private processes, which are accessed via the published public process. Service providers use service ontologies 120 and service composition schemas 130 to describe their services. Service descriptions are stored in an ontology based service repository 125. A simple query language is developed that allows service requesters to discover the services. Referring to FIG. 4, there are four elements in service descriptions 410 as follows: service ontology 415, service class or service composition schema, Service Level Agreements (SLAs) 430, and constraints 440.

Service ontology 415 defines basic concepts and terminologies that are used inside the domain. Service providers 135 need to specify which service class 422 or service composition schema 424 they support. Service providers 135 need to use service quality criteria 438 (e.g. execution cost, execution time, etc) to specify SLA 435 for services. Some service providers publish their SLAs in service description 410, while some may not publish SLAs in their service descriptions for confidentiality reasons. In the latter case, service providers need to provide methods that allow service requesters to query the SLAs 430.

Service providers also can specify the constraints on services. There are two kinds of constraints, namely data constraints 450 and flow constraints 460. Data constraints can be defined as value range or enumeration of all the possible values. Data constraints include input data constraints 452 and output data constraints 454. Input data constraints 452 define acceptable data values for the service, while output data constraints 454 give the possible output data values. Flow constraints 460 include precondition 462 and post-event 464. Precondition 462 indicates that before invoking the service, some condition must be satisfied. For example, it may require certain services as initialization. Post events 464 indicate that other services need to be involved. Memberships 466 are flows that share the same pre-condition and post-events.

Furthermore, service providers need to publish in the Service Repository 125 the invocation information (i.e. address, port number, protocol, etc.) enabling service requesters to access the service.

### 2.0 Event Model

An event is defined to be an instantaneous, atomic (happens completely or not at all) occurrence of interest at a point of time. For example, in a composite service instance, the interest in events comes mostly from the state change or data change that are produced by actions. Similar events can be grouped into an event type, and a type for events can be further classified into subtypes, resulting in an event type hierarchy as a class hierarchy. For example, events that come from end users can be grouped into a user event type, which can be further classified into more specific groups, such as USER/INITIAL, USER/CANCELLATION, etc. Different event types are distinguished by different event type names. Events of an event type may occur zero or more than once over the time window; the time of occurrence of and event is denoted by timestamp. An event type is expressed by an event expression, which is discussed in the following subsection. Formally, an event (either primitive or composite) is a function from time domain onto the Boolean value, i.e., true and false.

Definition (Event)

E is an Event, where E:T→True, False given by

E(t)=True if an event occurs at timestamp t, False otherwise

Primitive event types are predefined in the system. There are seven primitive event types, including user events, temporal events, service events, state events, action events and data change events.

User events are related to user's activities, such as issuing a request to execute some tasks. End users initiate user events.

Expression:

Event(USER/INITIAL, userName, userRole, userProfile)

This expression defines a USER/INITIAL event type: userName is the user who initials the event; userRole is the organization role of the user; userProfile is user's profile.

Temporal events can be classified into three subtypes: absolute, relative and periodic. An absolute temporal event is specified with an absolute value of time, while relative temporal event corresponds to a reference time point and offset. The reference point can be any events include an absolute temporal event. The periodic event will happen periodically.

Expression:

Event(TEMP/ABS, timeStamp)

This expression defines an absolute temporal event type, where timeStamp specifics the time points (e.g. 18:00 28/02/2002).

Expression:

Event(TEMP/RELATIVE, event, duration, relation)

This expression defines a relative temporal event type, where event is another event A that is defined in the system; duration gives a time window; if event A is an absolute temporal event, relation can be either before or after, otherwise, the relative temporal event must be after event A.

Expression:

Event(TEMP/PERIOD, timeStamp, timeWindow)

This expression defines a periodic temporal event type, where timeStamp specifies the time point, for example 18:00; time Window gives the time's range. For example, Event (TEMP/PERIOD, 00324, 01/01, 1998-2002) specifies a periodic temporal event that happens the first day of each year from 1998 to 2002.

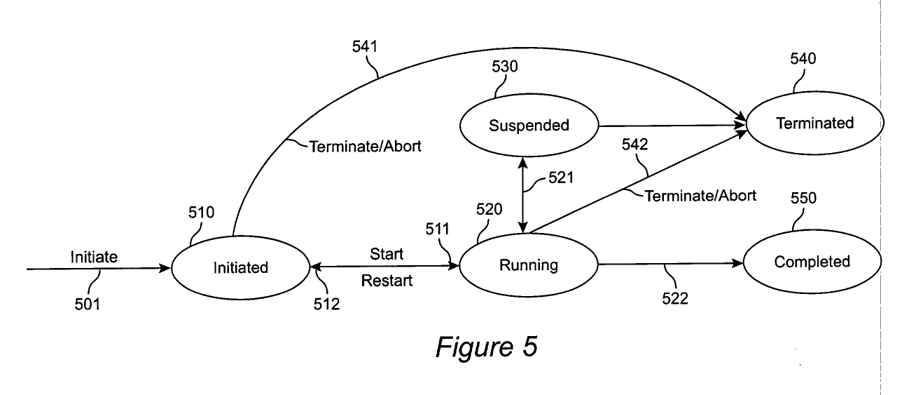

Task events correspond to running state of a task. The event happens when a task changes into the specific state. Referring to FIG. 5, a task has five running states: initiated 510, running 520, suspended 530, terminated 540 and finished or completed 550. Once initiated 501, a task may be started 511, or terminated after initiation 541 or terminated while running 542. A running task may be suspended or resumed 521, restarted 512 (i.e. returned to the “initiated” state 510) or completed 522.

Expression:

Event (TASK, scSchema/sClass, state, data)

This expression defines a task event. It is noted that the task can either involve primitive services or composite services. The scSchema is the task's service composition schema 424; sClass is the service classes 422 for the primitive service; state is the task's running state; data is task data.

Expression:

Event(Task, scSchema, sClass, state, data)

As described by this expression, if the task's service schema is a service composition schema 424, we can assume each primitive service in the service composition schema is a subtask. The scSchema is the tasks service composition schema 424; sClass is a service class 422 in the scSchema. Assume each primitive service in service composition schema 424 is a subtask, state is the subtask's running state; data is task data.

State Event. State events correspond to states defined in the state machine of a task. Such an even happens when the task executes the transition and target state is the specific event.

Expression:

Event (STATE, scSchema, state, data)

This expression defines a STATE event, where state is a specific state in the state machine; data is state related data.

Action events correspond to action defined in the state machine of a task. Such an event happens when a task execute the action.

Expression:

Event (ACTION, scSchema, action, data)

This expression defines an ACTION event, where action is a specific action in the state machine; data is action related data.

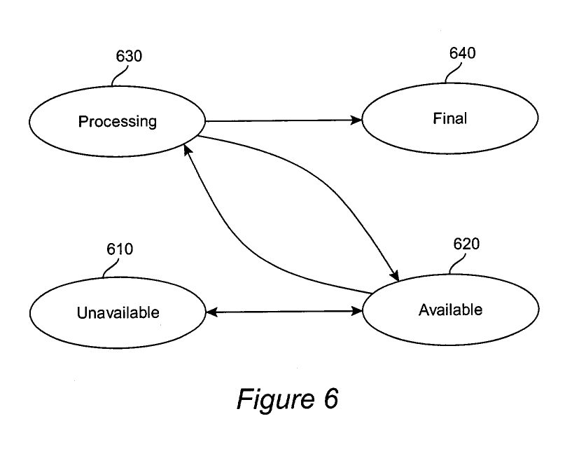

Data events correspond to the data states inside a task. Referring to FIG. 6, data has four states, namely unavailable 610, available 620, processing 630 and final 640. There are two kinds of data events:

Expression:

Event (DATA, scSchema/sClass, dataName, dataState, data)

This expression defines a data state change event, where dataName is a name of the data, dataState is the target data state, and data is event related data. This event occurs when the data state changes to dataState.

Expression:

Event(DATA, scSchema/sClass, dataName, value, data)

This expression defines a data state value event, where dataName is a name of the data and value is the target value; data is other related data. This event occurs when the data's value changes to value.

Primitive events discussed so far are useful to modeling simple business rules. However, it is necessary to combine some primitive events to a composite event. In this invention, a composite event is defined by applying an event operator to constituent events that are either primitive events or other composite events.

Event operators are enumerated as follows:

OR e] O(e₁ OR e₂): the event is detected when either of the component events has occurred.

AND(e₁ AND e₂): the event is detected when both of the component events have occurred.

SEQ(e₁; e₂): the event is detected when two component events occur in a sequence.

NEG(Not(e₁ (t₁, t₂))): the event is detected when event doesn't occur in time window (t₁, t₂).

In this subsection, we present syntax and semantic of conditions in ECA rules. While rule inference algorithms that are presented later depend on the syntax and semantic chosen here, the algorithms can easily be adapted to work with different choices for syntax and semantics. Conditions are built from atomic conditions using Boolean operations AND, OR and NOT Atomic conditions are Boolean functions ƒ(op, t₁, t₂, . . . tₙ) where op is an operation that returns true or false, tᵢ are terms either a constant or data name. Here, data name is regarded as value of the data. For example, data name represents value of (i.e. Value(A)). Atomic conditions can be tested only when data are in final state. It is noted that the data in conditions can be user's information, runtime variable, event related data, etc.

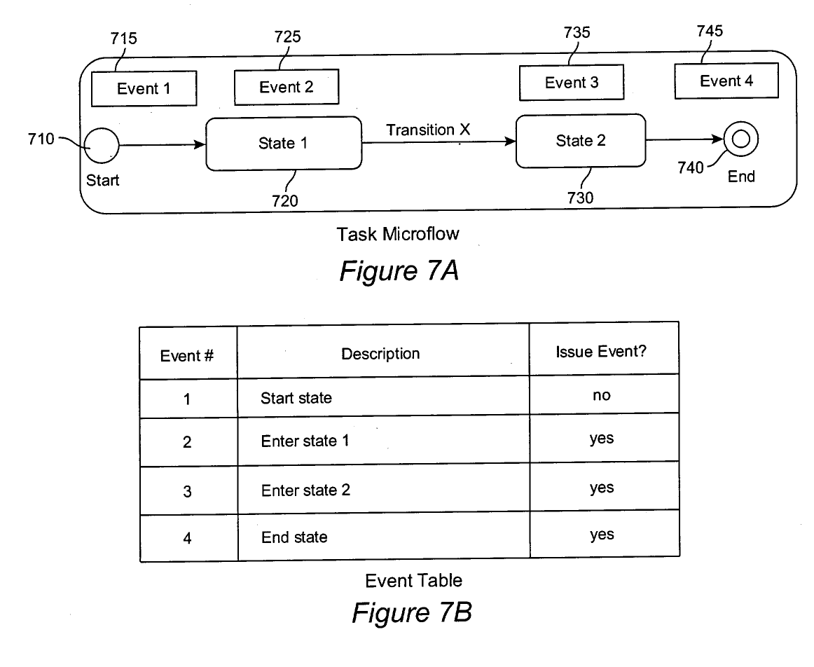

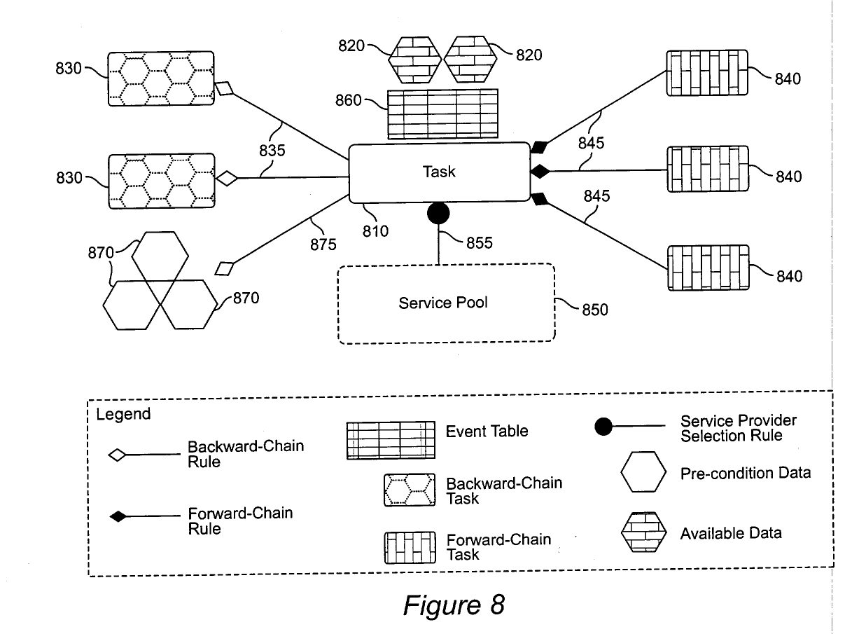

When executing a business process the workflow engine invokes service providers to perform tasks. The workflow engine needs to know what state the service provider's service is in as the service performs work. This is particularly true for service providers whose services are long running, asynchronous, or transactional. To coordinate this interaction, when the workflow engine assigns a task to a service provider, it consults the business rules and service descriptions and generates an event table that is sent to the service provider along with service execution instructions. This event table specifies what events the workflow manager is interested in following. The service provider sends event notifications when any event in an event table occurs during the execution of services. Referring to FIGS. 7A and 7B, there is shown a task microflow (FIG. 7A) that supports events for workflow states and transitions. The accompanying event table (FIG. 7B) specifies what events the service requester is interested in.

In FIG. 7A there is shown a simple workflow example for a task. There is a Start state 710, a transition to State 1 720, then a transition to State 2 730, and finally transition to an End state 740. Entry into each of these states provides a corresponding event issuing option that may be of interest to a service requester, as shown in FIG. 7B. Putting the task in the Start state 710 is an event 715 which may be issued to an interested service requester. The Event Table shown in FIG. 7B is prepared for a particular service requester, and shows that nothing is to be issued to this particular service requester upon the occurrence of Event 1 715. Similarly, transition to State 1 720 is an event 725, transition to State 2 730 is an event 735, and transition to End state 740 is an event 745. As shown in FIG. 7B, this particular service requester has chosen to receive notification of Event 2 725, Event 3 735 and Event 4 745.

### 3.0 Business Rule Model

Central to PLM-web is a new framework that enables dynamic business process composition and execution, using business rules, without the aid of any predefined workflow schemas. This is accomplished by business rule inferencing that employs backward and forward rule chaining techniques coupled with applied algorithms and logic that are described in this invention. We refer to this dynamic business process composition framework as “PLM-flow”.

In implementing this invention, it is preferable to use the business rules to model the business logic. Business rules are statements about how the business is done, i.e., about guidelines and restrictions with respect to states and business processes in an enterprise. Enterprises are changing constantly: entering into new markets, introducing new products, fine-tuning themselves through mergers, acquisitions, alliances and divestitures. The rate of change is rapidly increasing. Such changes can be easily modeled by modifying the business rules. A business rule-driven framework is an agile solution that provides the flexibility to quickly change an enterprise's workflow system whenever the business changes.

PLM-flow is supported by several fundamental concepts: service ontology, PLM-flow,. Service ontology is used to model basic concepts, terminologies and functions uniquely apply to different business domains. Service ontologies are used to define service composition schemas, service descriptions and business rules, as described above in reference to FIGS. 2-7. PLM-flow is the model that facilities dynamic business processes composition in accordance with the invention. The following is the formal definition of PLM-flow.

Definition (PLM-flow). A PLM-flow is a 2-tuple Tasks,AvailData, where:

1. Tasks is a set of Task. A Task is further defined by a 4-tuple: ServiceSchema, BCTasks, FCTasks, RCData, where:

ServiceSchema gives details of task's functionality; it can be a service class, or service composition schema.

BCTasks are tasks that are inferred by backward-chain rules,

FCTasks are tasks that are inferred by forward-chain rules.

RCData is the set of data that need to be available before executing the task.

2. AvailData is available data set that supports a giving business process.

PLM-flow is a task centric process model. Referring to FIG. 8, in this model, instead of requiring end users to predict how to achieve a certain goal by defining detailed workflow schemas, end users only need to specify the service schema of the target task 810 (that represents the end objective of the business process) and provide necessary input data 820. Initially, the target task 810 is the sole task in the PLM-flow. Based on rule inference, the system dynamically adds tasks (backward chain tasks 830 based on backward chain rules 835 and forward chain tasks 840 based on forward chain rules 845) and related pre-condition data 870 (based on backward chain rules 875) into the PLM-flow to compose the projected execution path from start to finish. During execution, the system modifies the PLM-flow (e.g. adds new tasks, modifies and removes tasks) based on events, rules and rule inference. For each task, control flows are represented as rules that are dynamically bound to the tasks during the execution; data flows are represented as data source rules. During execution the service provider is selected from a service pool 850 using service provider selection rules 855. Event tables 860 for task 810 will be generated as needed for service requesters. If business conditions change, the user need only change the rules accordingly. The system will continue to modify the PLM-flow to implement the rules, responsive to events and responsive to rule changes and data provided by the user.

An initial task represents the end user's starting point for a business process; a business objective represents a goal that the end user wants to achieve within a business process. In PLM-flow a business objective is described as a target task 810 that an end user wants to achieve, for example, changing an engine type in an automobile. Both initial state and business objective are defined in terms of a service ontology. For the initial state, users need to specify the operation name, input data and context; for the business objectives, users specify the operation name and provide constraints on input and output data.

An example the PLM-flow process is shown in Table 1, in which an XML document illustrates a business objective where a user wants to change a leaded petrol engine to an unleaded petrol engine for a sedan car. The target task is expressed by the user as “change engine for sedan” and an “Automoble Engineer” service is identified for performance of the task, within the constraints that the car is a sedan, the original engine is a leaded petrol engine, and the new engine is to be an unleaded petrol engine.

TABLE 1
XML representation of a business objective

```
< businessObjectives >
  <User Name=“Gerg” Role=“Chief Engineer” > <User>
  <targetTask Name=“change engine for sedan”>
    <ontology-service NAME=“Automobile Engineer” >
      < operation NAME=“changeEngine” > </operation>
      < data-constraint >
        <variable dataName=“Car” dataItemName=“type” />
        <op value=“=”/>
        <value>“sedan”</value>
      </data-constraint >
      < data-constraints >
        <variable dataName=“originalEngine” dataItemName=“type” />
        <op value=“=”/>
        <value>“Leaded Petrol”</value>
      </data-constraints >
      < data-constraint >
        <variable dataName=“newEngine” dataItemName=“type” />
        <op value=“=”/>
        <value>“Unleaded Petrol”</value>
      </data-constraint >
  </targetTask >
</ businessObjectives >
```

Business rules are used to describe the business logic and policy of an enterprise. The following subsections describe the event model, and then give the details of six types of rules. Business rules are defined as Event-Condition-Action (ECA) rules that are stored in a rule base and are executed by a rule inference engine.

An event is defined to be an instantaneous and atomic occurrence at a point of time. For example, in a composite service instance, an event may be initiated from a state change or a data change that is produced by actions. Similar events are grouped into an event type, and are further classified into subtypes, resulting in an event type hierarchy. For example, events that come from end users are grouped into a user event type, which are further classified into more specific groups, such as USER/INITIAL or USER/CANCELLATION. Different event types are distinguished by different event type names. There are several event types including: user events, temporal events, task events, state events, action events and data change events.

A rule condition is a threshold that determines if a rule should be fired. Rule conditions are built from atomic conditions using Boolean operations AND, OR and NOT. An atomic condition is a Boolean function ƒ(op, t (subscript: 1), t(subscript: 2), . . . t(subscript: n)), where op is an operation that returns true or false, t(subscript: i) are terms of either a constant or data name. A data name is regarded as value of the data. For example, data name A represents value of A (i.e. Value(A)). There are not restrictions on data referred to in a condition, which can include user information, runtime variables or event related data.

There are four types of actions in business rules: PLM-flow management actions, PLM-flow execution management actions, composite services modification actions and services coordination actions. PLM-flow schema management actions generate the PLM-flow schema during the run time. These actions include:

Initial (OUTPUT PLMflow pf)

This action initiates an empty PLM-flow for end users.

Authorize(OUTPUT ServiceCompositionSchema scSchema)

This action indicates the end users are authorized to use the service composition schema to perform the business process.

Authorize(OUTPUT ServiceClass sClass)

This action indicates the end users are authorized to use the service class to perform the business process.

AppendPLMFlow(OUTPUT ServiceCompositionSchema scSchema)

This action adds a task to PLM-flow. The task's service schema is scSchema.

AppendPLMFlow(OUTPUT ServiceClass sClass)

This action adds a task to PLM-flow. The task's service schema is sClass.

PLM-flow execution management actions control the execution of the PLM-flow. These actions include:

Exec(INPUT ServiceCompositionSchema scSchema, OUTPUT ServiceProvider sProvider; INPUT SLA sla; INPUT XMLDoc inputData; OUTPUT ServiceInstance si)

This action assigns Service Provider sProvider to execute the task that has service composition schema scSchema, conforming to SLA sla. The definition of service instance is given as follows:

Definition (Service Instance). SI is a service instance, if SI is a 5-tuple, SI=(scSchema/sClass, flowID, sID, serviceProvider, SLA) Where:

scSchema is the service composition schema, while sClass is service class;

flowID is the PLM-flow instance's ID; sID is service's own ID;

serviceProvider is the placeholder for those who execute the services;

SLA is the Service Level Agreement related to the execution of service instance SI.

Exec(INPUT ServiceClass sClass; OUTPUT ServiceProvider sProvider; INPUT SLA sla, INPUT XMLDoc inputData, OUTPUT ServiceInstance si)

This action assigns Service Provider sProvider to execute task based on Service Class sClass, conforming to SLA sla.

Drop(INPUT ServiceCompositionSchema scSchema)

This action drops tasks that have service schema scSchema.

Drop(INPUT ServiceClass sClass)

This action drops tasks that have service schema sClass.

Suspend(INPUT ServiceCompositionSchema scSchema; INPUT Event e; INPUT Condition c)

This action suspends the tasks that have service schema on scSchema until event e is emmitted and the condition c is satisfied.

Suspend(INPUT ServiceClass sClass,;INPUT Event e, INPUT Condition c)

This action suspends the tasks that have service schema sClass until event e is emitted and the condition c is satisfied.

There are three kinds of actions that are used to modify a composite service instance.

AddAction(INPUT ServiceCompositionSchema scSchema, INPUT Transition tr; INPUT Action action)

This action adds an action into a transition of a composite service instance in a task.

DeleteAction(INPUT ServiceCompositionSchema scSchema:INPUT Transition tr; INPUT Action action)

This action deletes an action in a transition of a composite service instance in a task.

Migrate(INPUT ServiceCompositionSchema scSchema1; ServiceCompositionSchema scSchema2)

This action migrates composite service instance from schema scSchema1 to scSchema2.

Different services may need to coordinate by exchanging the data.

SendMSG(INPUT ServiceCompositionSchema scSchema1 INPUT ServiceCompositionSchema scSchema2; INPUT XMLDoc data)

This action sends the data from a task that has service schema scSchema1 to another task that has service schema scSchema2.

SendMSG(INPUT ServiceCompositionSchema scSchema, INPUT ServiceClass sClass; INPUT XMLDoc data)

This action sends the data from a task that has service schema scSchema to another task that has service schema sClass.

SendMSG(INPUT ServiceClass sClass1;INPUT ServiceClass sClass2; INPUT XMLDoc data)

This action sends the data from a task that has service schema sClass1 to another task that has service schema sClass2.

SendMSG(INPUT ServiceClass sClass; INPUT ServiceCompositionSchema scSchema; INPUT XMLDoc data)

This action sends the data from a task that has service schema sClass to another task that has service schema scSchema.

There are six kinds of business rule templates that we present as follows.

Template 1: User Authorization Rules.

Expression:

Event(User/Request)|(Condition) {Authorize(ServiceSchema)}

User authorization rules give the service schema (i.e. service composition schema or service class) that end users are authorized to use.

Template 2: PLM-flow Schema Management Rules.

PLM-flow schema management rules are used to dynamically create PLM-Flow schemas. There are two kinds of PLM-flow schema management rules, namely backward-chain rules and forward-chain rules.

Backward-chain Rules:

Expression:

Event(*)|(ServiceSchema==*)

{Precondition(FlowConstraints( )|DataConstraints( ))}

Backward-chain rules indicate the precondition of executing a task. The precondition can be data constraints, which means the data must available before the execution of the service. The precondition can also be flow constraints, which means execution of task requires other tasks to be finished first. In some cases, FlowConstraints( ) may have AND or OR operations. For example, FlowConstraints( )={Task_A}OR{Task_B}, indicates either Task_A or Task_B need to be finished first.

Example (Backward-chain Rule).

Event(*) (ServiceSchema==costAnalysis) {Precondition (FlowConstraints( )={‘testPlanning’})}

In this example, the rule indicates before executing the task of costAnalysis, the task of testPlanning needs to be finished first.

Forward-chain Rules:

Expression:

Event(*)|(Condition) {AppendPLMFlow(ServiceSchema)|Drop(ServiceSchema)}

Forward-chain rules indicate some actions may need to be invoked as a consequence of task execution.

Example (Forward-chain Rule).

Event (TASK, *, costAnalysis, *, FINISHED)|(cost>$2000){AppendPLMFlow(‘audit_{—}2’)}

In this example, the rule adds the task of audit_{—}2 into the PLM Flow if the task of costAnalysis is finished and the cost is greater than $2000.

Template 3: Service Provider Selection Rules.

Service selection is a very important issue in business process management. While PLM-flow schema management rules compose valid schema compositions, they do not address how to select a provider to perform the service. Service provider selection rules establish the relationship of criteria and analytic function used in evaluating service provider selection.

Expression:

Event(ProviderSelection, {ServiceSchema1 . . . ServiceSchemaN})|(Condition){ƒ}

Here, we assume that for each task, the system discovers a set of service providers and each service provider has multiple SLAs to perform the service. The action ƒ is a function that evaluates the SLAs and returns a 3-tuple response {ServiceSchema, ServiceProvider, SLA}.

Template 4: PLM-flow Execution Management Rules.

The system uses the PLM-flow execution manages rules to control the execution of tasks. For example, when data is available and a service provider is selected, the system needs to assign the task to the service provider.

Expression:

Event(*)|(Condition) {Suspend|AddAction|DeleteAction|Migrate}}

The event corresponds to task event, user event or temporal event. Actions are used to control the execution of PLM-flow instances.

Example (PLM-flow Execution Management Rule).

Event(ACTION, CostEstimate, *, FINISHED)|(part=‘engine’cost>$2000) {Suspend(clashAnalysis(engine))}

In this example, if the engine's CostEstimate is finished and cost is greater than $2000, the task of clashAnalysis on the engine needs to be suspended.

Template 5: Service Coordination Rules.

The tasks executed by service providers need to coordinate by exchanging the data or synchronizing control. Coordination rules specify data flow or control flow among the task execution.

Expression: Event(*)|(Condition){SendMSG( )}

The event corresponds to task event, user event or temporal event. The result of an action is the issuance of a message from one task to another.

Template 6: Data Source Rules.

Locating data source is an important aspect during the execution of a business process. Data source rules are used to specify how to obtain data. When the system initiates tasks, it needs to consult the data source rules to locate the data. Here, we assume the data source is kind of service that returns the requested data.

Expression:

Event(*)|(Ontology=‘*’ DataName=‘*’){ServiceSchema}

Example (Data Source Rule)

Event( )|(Ontology=‘Engineering Test’ DataName=‘AA’){QueryAA}

In this example, the rule specifies data AA is obtained by involving the service QueryAA.

The rules defined by the above describes templates can be represented in an Extended Markup Language (XML) format. This format facilitates definition, implementation and execution of the business rules by rule composers and business rule execution engines. The Business rule definition schema is presented in Appendix 1. Using this XML schema, an example of a rule defined is presented in Table 2. In this example a backward chaining rule is defined, that is fired when an EngineReplacement event occurs and the condition is equal to DieselEngine, in which case the (backward chaining) action is to add the required precondition PartApproval rule into the schema.

TABLE 2
Example of Rule Represented in XML

```
- <Rule RuleType=“BCRule”>
  - <BCRule>
  <RuleType>BCRule</RuleType>
  <RuleID>R001</RuleID>
  <RuleName>ChangeEngineRule</RuleName>
  - <Event>
    ServiceOntologyName>AutomobileEngineer
    </ServiceOntologyName>
    <EventType>TaskEvent</EventType>
    <EventID>E0001</EventID>
    <ServiceSchemaName>EngineReplacement</ServiceSchemaName>
  </Event>
  - <Condition>
    - <SimpleConditon>
      - <Data>
        - <InputData>
        <DataName>NewEngineType</DataName>
        </InputData>
      </Data>
        <Operation>EQUAL</Operation>
        <ConditionValue>DieselEngine</ConditionValue>
    </SimpleConditon>
  </Condition>
    - <Actions>
      - <Action>
        <ActionType>SchemaAction</ActionType>
        <ServiceOntologyName>AutomobileEngineer
        </ServiceOntologyName>
        <ServiceSchemaName>PartApproval</ServiceSchemaName>
      </Action>
    </Actions>
  </BCRule>
</Rule>
```

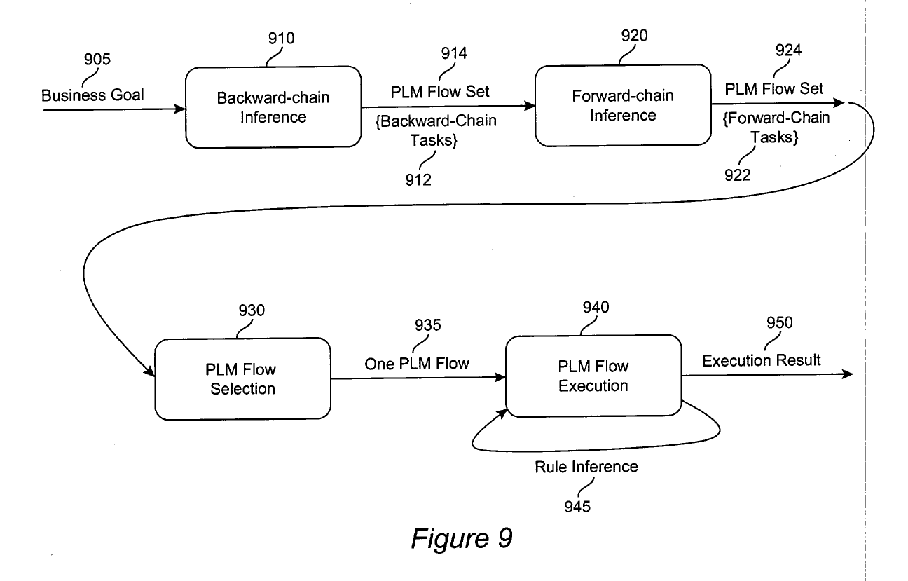

The PLM-flow process model is used to realize the dynamic business process composition and execution by rule inference. Business process composition and execution in PLM-flow involves four major steps as illustrated in FIG. 9:

1. Backward-chain Inference 910. Initially, when the system receives an end user's request, there is only one task (i.e. target task responsive to a business goal 905) in the PLM-flow. In this phase, Back-chain inference discovers the necessary tasks (i.e. backward-chain tasks 912) that must be completed before executing the target task. Since it is possible to have multiple paths to reach the target task, Back-chain inference creates a set 914 of PLM-flows.

2. Forward-chain Inference 920. Forward-chain inference predicts which additional tasks (i.e. forward-chain tasks 922) are added into the PLM-flow set 924 as a consequence of executing backward-chain tasks.

3. PLM-flow Selection 930. When multiple PLM-flows are created, one of them 935 needs to be selected, typically based on their quality of service.

4. PLM-flow Execution 940. In this phase, a PLM-flow instance is started. The system will assign tasks to service providers to execute them. When the system receives events from service providers, it uses events to trigger the rule inference 945. The actions that are required by rule inference results include modifying the PLM-flow instance, enabling new tasks, etc. The system also returns task execution results 950 to users.

Details on these four steps are presented below. A formal description of the Backward-chain Inference algorithm is found in Appendix 2 as Algorithm 1. Algorithm 1 discovers task execution paths for the target task using backward-chain rules as follows:

1. The backward-chain inference 910 phase searches the backward-chain rules for the target task. Then, starting at the target task, rules are used to infer the backward-chain tasks 912 that compose an execution path. The algorithm recursively infers backward-chain tasks and the inference will not stop until there are no more new backward-chain tasks found.

2. In the case that there exists OR operations in backward-chain rules, more than one PLM-flow may be generated. If so, the output of the algorithm is a set 914 of PLM-flows. Prior to execution, only one of the PLM-flows is selected by the system. The selection method is described later in this invention.

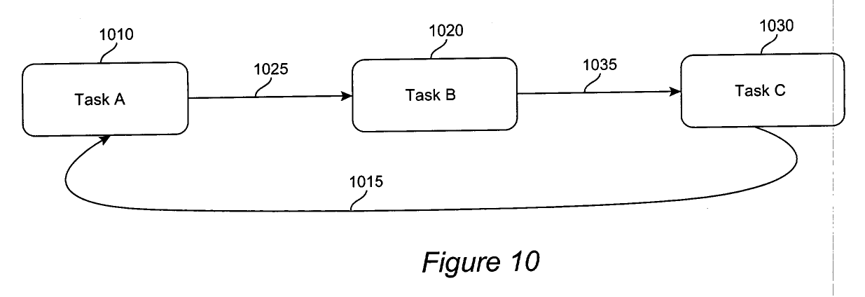

3. If the inferred task already exists in the execution path, the algorithm detects whether there is a cyclic graph in the path. As shown in FIG. 10, a cyclic graph indicates there is a conflict among the backward-chain rules, which causes the target task to be unreachable. Task B 1020 is a backward chain 1035 of Task C 1030, Task A 1010 is a backward-chain 1025 of Task B 1020, but task C 1030 is a backward-chain 1015 of Task A 1010. The inference process terminates and the PLM-flow is abandoned.

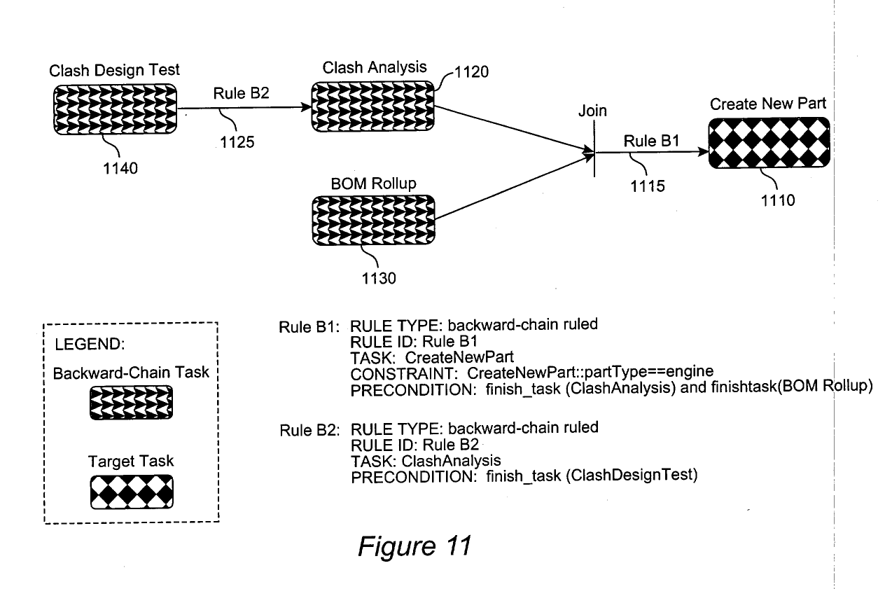

An example of backward-chain inference is illustrated in FIG. 11. In this example, the target task is Create New Part 1110. Based on backward-chain rule rb1 1115 Clash Analysis 1120 and BOM Rollup 1130 are added into the PLM-flow as backward-chain tasks. Since Clash Analysis also has a backward-chain rule rb2 1125, Clash Design 1140 is added into the PLM-flow as the backward-chain task of Clash Analysis 1120.

A PLM-flow schema that is generated by backward-chain inference is not complete, since the forward-chain rules may add new tasks to the PLM-flow. A Forward-chain Inference algorithm is used to predict additional forward-chain tasks that are added into the PLM-flow during execution. A formal description of this algorithm is found in Appendix 3 as Algorithm 2.

For each task t in PLM-flow, we assume t has been completed; R is the set of forward-chain rules that are triggered by the event of completing task t. For each rule r in R, the condition part is regarded as a condition tree. The formal definition of a condition tree is as follows: Definition (Condition Tree). CT is a Condition Tree of the condition C in rule r, if CT has two types of nodes: parent nodes and leaf nodes. Parent nodes represent the Boolean operations in condition C. Each atomic condition in C is represented by two kinds of leaf nodes that share an AND node. One type of leaf node represents the state function of data; the other type of leaf node represents the expression of an atomic condition, for example “budget>$1000”. The state function returns true when the data is available, otherwise returns uncertain. The possible results of Boolean operations on nodes combining leafs having “Uncertain” results are given in Table 3.

TABLE 3
Operation Result on Uncertain

| Operation | Expression | Result |
|---|---|---|
| AND | True AND Uncertain | Uncertain |
| | False AND Uncertain | Uncertain |
| | Uncertain AND Uncertain | Uncertain |
| OR | True OR Uncertain | True |
| | False OR Uncertain | Uncertain |
| | Uncertain OR Uncertain | Uncertain |
| NOT | NOT Uncertain | Uncertain |

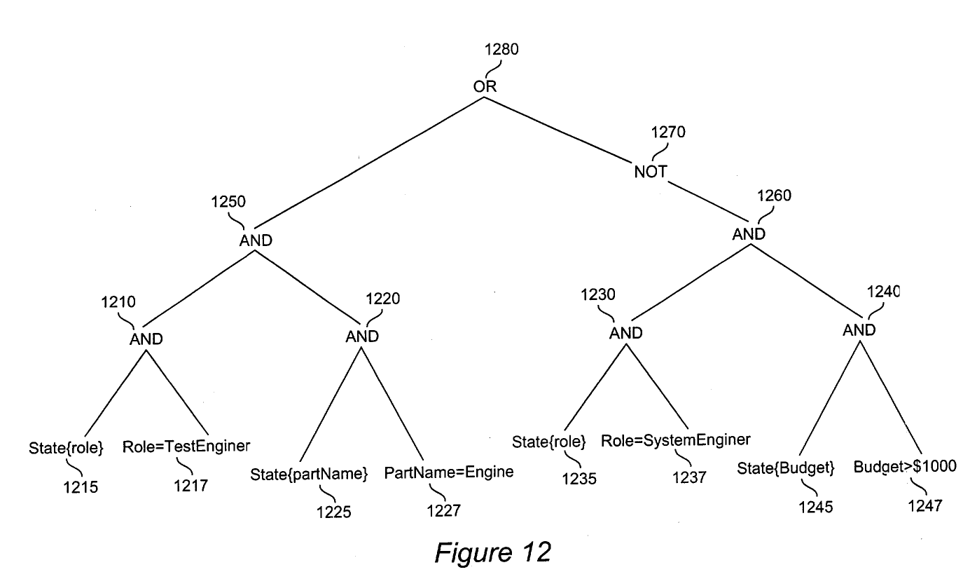

Turning to FIG. 12, there is shown the condition tree of condition C, where C=((Role=TestEngineer) 1210 AND 1250 (partName=Engine) 1220) OR 1280 (NOT 1270 ( (Role=SystemEngineer) 1230 AND (Budget>$1000) 1240)). The atomic conditions at the bottom of the tree are represented by a state function ( 1215, 1225, 1235 and 1245, respectively) connected to a data condition ( 1217, 1227, 1237 and 1247, respectively) by an AND operator ( 1210, 1220, 1230 and 1240, respectively).

If the condition tree test result is true or false (and not uncertain), then the Forward-chain inference algorithm infers forward-chain tasks. In the case that the condition tree is true, a forward-chain task is added into the PLM-flow. If the result is false, then the algorithm checks whether there are conflicts among the rules. There are two types of conflicts: a conflict between a forward-chain rule and a backward-chain rule; or a conflict between two forward-chain rules. For example, suppose that in backward-chain rule r_{b}, task tᵢ is a backward-chain task of task tⱼ while in forward-chain rule r_{f} task tⱼ is forward-chain task of tᵢ. If the condition in r_{f}is false, then there is a conflict between the forward-chain rule and the backward-chain rule. In another example, suppose forward-chain rule rf₁ enables the task tⱼ, while forward-chain rule rf₂ disables the task tⱼ. Here there is a conflict between rules rf₁ and rf₂. Such conflicts indicate the target task is unreachable in the PLM-flow. In this case, the inference procedure terminates and the PLM-flow is abandoned. The Forward-chain Inference algorithm also detects whether there exists a cyclic graph in PLM-flow as previously discussed in connection with FIG. 10.

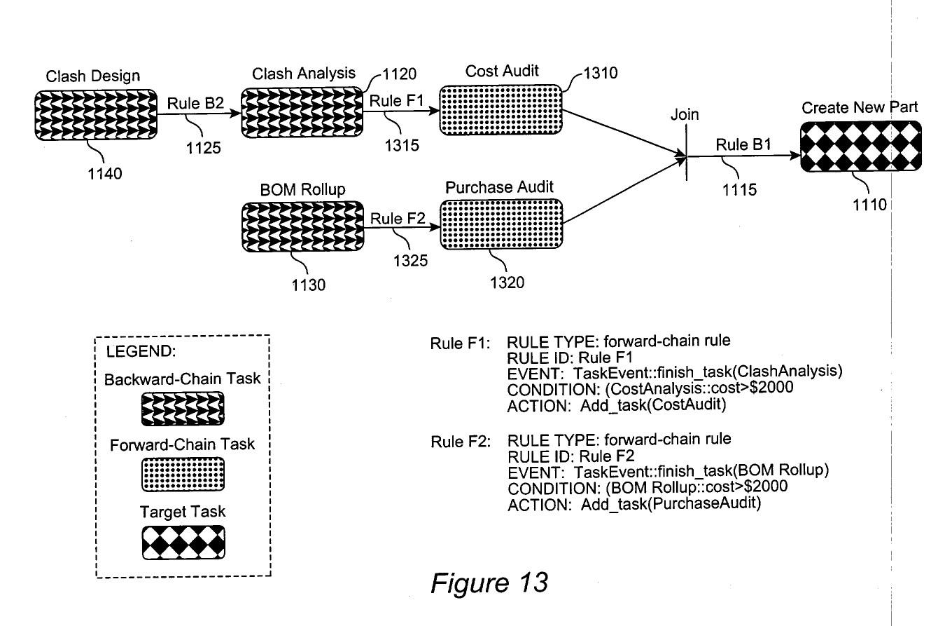

Using the results of backward-chaining shown in FIG. 11 as a template, application of the forward-chain algorithm is shown in FIG. 13. Forward-chain rule rf₁ 1315 from the Clash Analysis task 1120 generates a Cost Audit task 1310. Forward-chain rule rf₂ from the BOM Rollup task 1130 generates a Purchase Audit task 1320.

In the case that the test result of the condition tree is uncertain, the algorithm conducts an ad-hoc inference as follows:

1. It identifies all data that is required by the rule conditions. Assume all the data required by rule r is D, while currently available data is Dc. Therefore Du (Du=D−Dc) is the set of unknown data that is required by the rule r.

2. For each d ε Du, the algorithm searches its data source and computes its Frequency Table (see definition below) that enables the system to postulate the likelihood that the condition is true or false. For example, d ε Du, if d is an output of task t in PLM-flow P, we assume d is provided by task t. By applying the service provider selection rules on task t, the algorithm locates a service provider. By querying the service provider's past execution results that are logged in the system, a frequency table is generated.

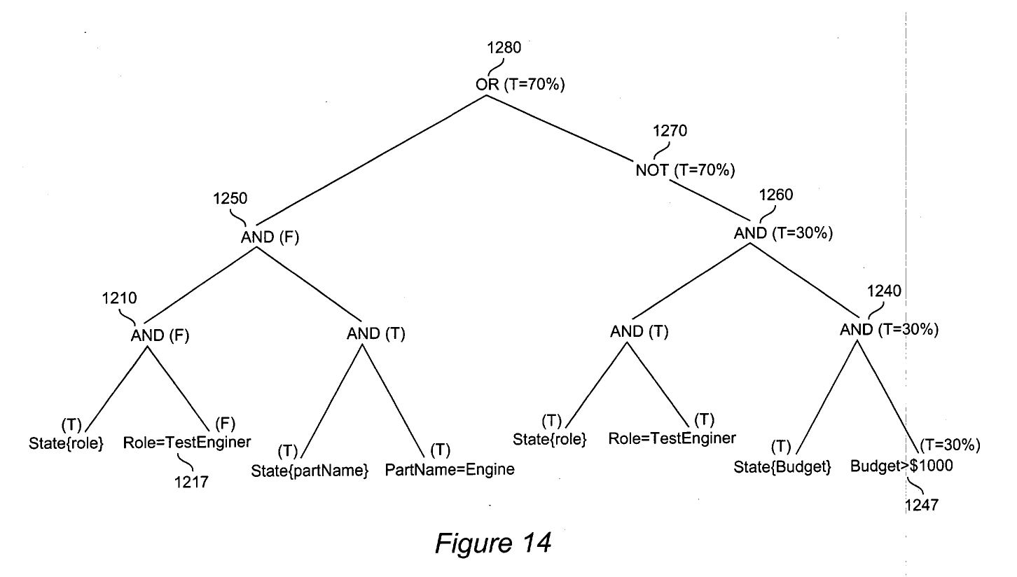

3. Assuming for each d (dεDu), State(d)=true, the algorithm evaluates the atomic conditions based on the frequency table, which generates an annotated condition tree as illustrated in FIG. 14, which is an annotation of the condition tree of FIG. 12. In the annotated tree, the root node 1280 gives the probability that the condition tree is true. As shown in the annotation, the role of TestEngineer returns FALSE, resulting in FALSE returns for nodes 1210 and 1250. On the opposite side of the OR 1280 operation all conditions are true except the condition “Budget>$1000” 1247 is given a probability of 30%, which results in 30% probabilities for nodes 1240 and 1260. This probability is inverted by the NOT operator at node 1270, yielding a probability of 70% at the root node 1280.

4. If the probability of the enabling task is greater than a given threshold then the algorithm adds the task into PLM-flow, otherwise, the algorithm disables the task.

5. Ad-hoc inference also detects the potential conflicts in the PLM-flow. Definition (Frequency Table): FT is Frequency Table of data A, if FT={v₁, v₂, . . . vₙ,}. vᵢε FT, vᵢ is a 2-tuple <per,ran>, where ran is the value range of the data, per is the possibility of data's value in the range.

Example (Frequency Table): FT is Frequency Table of data PurchaseCost, FT={v₁, v₂v₃}. v₁=<[1000,1500], 0.1>, v₂=<[1500,2500], 0.5>, v₃=<[2500,3500], 0.4>

Referring again to FIG. 13, since the forward-chain rule rf₁ 1315 for Clash Analysis 1120 has a condition part that is empty, the probability of Cost Audit 1310 is 100%. For BOM Rollup 1130, the forward-chain rule rf₂ has a condition of PurchaseCost>$1500. Suppose based on past performance the probability of enabling the rule is 90%. Thus, Purchase Audit is added into the PLM-flow with a probability of 90%.

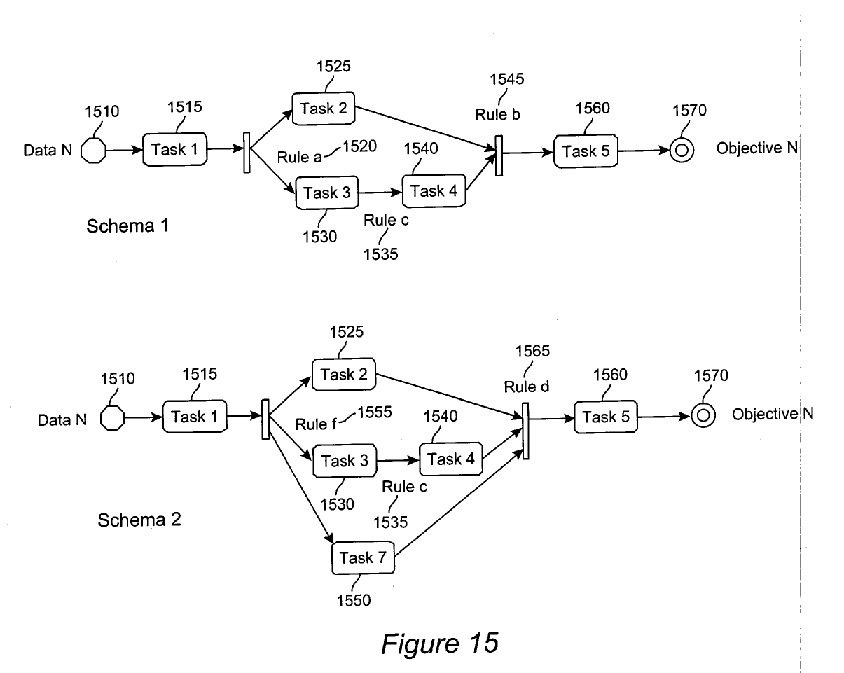

In Backward-chain inference and Forward-chain inference, a set of candidate PLM-flows (workflow schemas) is generated prior to execution. In the case where multiple schemas are generated, each conforms to the business rules; however, the system determines that different paths are possible to get from the starting state to the completion state. See FIG. 15 for an illustration of multiple workflow schemas. Both shemas begin with Task 1 1515 using Data N 1510 and conclude with Task 5 1560 reaching objective N 1570. In both, Task 3 1530 and Task 4 1540 are connected by Rule c 1535. In Schema 1, Task 2 1525 and Task 3 1530 are connected to Task 1 1515 by Rule a 1520, and Task 2 1525 and Task 4 1540 are connected to Task 5 1560 by Rule b 1545. The alternative Schema 2 is similar, but Rule f 1555 connects Task 1 1515 to Task 2 1525, Task 3 1530 and an additional Task 7 1550, and Rule d 1565 connects Task 4 1540 and the additional Task 7 1550 to Task 5 1560.

The user or the system may be empowered to recommend and select the appropriate schema. Recommendation by the system is based on such criteria as preferred business rules or the frequency the schema has been historically used.

For each PLM-flow the system uses the service provider selection rules to select the service providers for every task. Based on these service provider selections the workflow engine can estimate the quality of the PLM-flow. The quality criteria can include total execution time, execution cost, etc. There are various well established methodologies and algorithms that can be applied to determine an optimum selection, and the invention may be practiced with any of them. The PLM-flow from the set of PLM-flows generated by the system that is evaluated to be of the highest quality is used for execution.

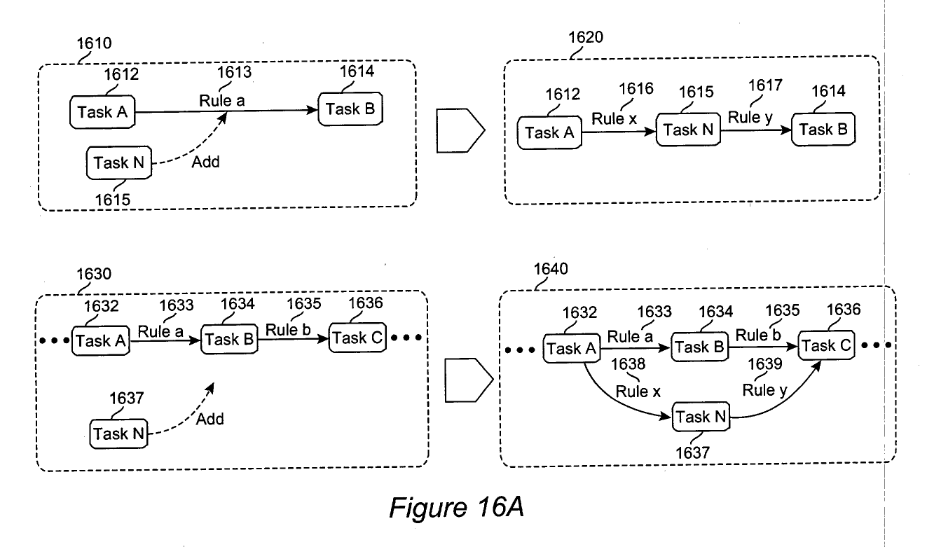

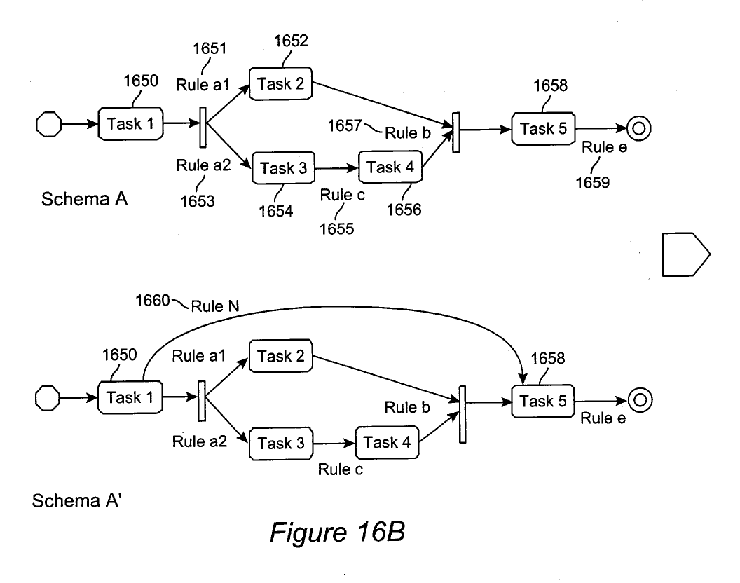

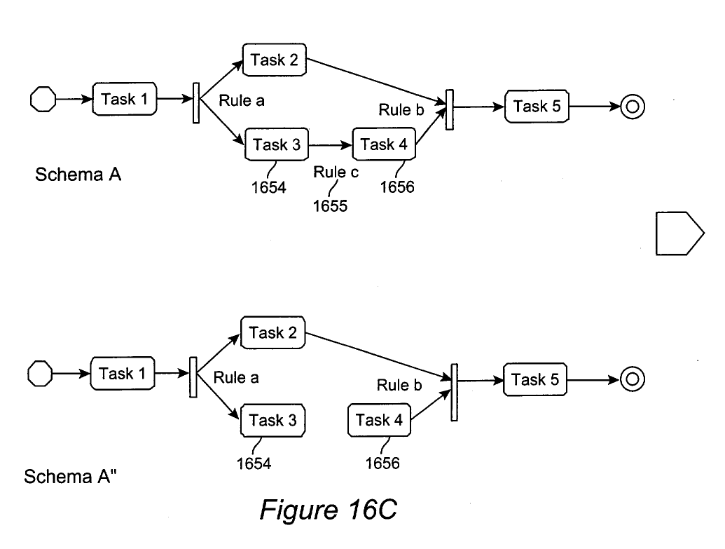

The set of candidate workflow schemas generated by backward-chain inference and forward-chain inference may not be what the user intends, even through they conform to the established business rules. This implies that the rule set needs to be modified or supplemented with additional rules. In such a case the user is afforded the opportunity to modify a workflow schema by adding or deleting tasks and transitions. The consequence of modifying a schema is the automatic generation of new business rules that represent the change the user is making. These new rule modifications can be enacted for the current workflow, or be added permanently into the rule repository. See FIGS. 16A, 16B and 16C for an illustration of modifications, including: adding a task, adding a transition and deleting a transition.

In FIG. 16A there are shown two examples of adding a task. In diagram 1610 Rule a 1613 connects Task A 1612 and Task B 1614, with Task N 1615 to be added between Task A 1612 and Task B 1614. The consequence of this addition is shown in diagram 1620, with generation of new Rule x 1616 connecting Task A 1612 and Task N 1616 and new Rule y 1617 connecting Task N 1615 and Task B 1614. Note that Rule a 1613 is not used in the resulting diagram 1620. Diagrams 1630 and 1640 show a different form of addition. Rule a 1633 connects Task A 1632 and Task B 1634, and Rule b 1635 connects Task B 1634 and Task C 1636, with Task N 1637 to be added. The consequence of this addition is shown in diagram 1640, with generation of new Rule x 1638 connecting Task A 1632 and Task N 1637 and new Rule y 1639 connecting Task N 1637 and Task C 1636.

The addition of a transition is shown in FIG. 16B. Schema A is defined by Task 1 1650 connected to Task 2 1652 by Rule a1 1651 and connected to Task 3 1654 by Rule a2 1653, with Rule c 1655 connecting Task 3 1654 to Task 4 1656 and Rule b 1657 connecting Task 2 1652 and Task 4 1656 to Task 5 1658, and Task 5 1658 being concluded by Rule e 1659. In Schema A′ there is shown an added transition from Task 1 1650 to Task 5 1658 by operation of Rule N 1660.

Deletion of a transition is shown in FIG. 16C. Note Rule c 1655 in Schema A, which defines a transition between Task 3 1654 and Task 4 1656. The result of deleting this transition is shown in Schema A″, which shows no connection between Task 3 1654 and Task 4 1656.

When a PLM-flow is selected, the workflow engine starts the execution of PLM-flow instance. In this subsection, we define the concept of an executable task and give details about executing PLM-flow. In PLM-flow, each task has four states: initial, executable, executing, completed and failure. Formal definition of an executable task is as follows: Definition (Executable Task). Task A=<ServiceSchema, BCTasks, FCTasks, RCData>, AvailData is the available data in PLM-flow. A is Executable Task, if

RCData ∩ AvailData=RCData.

All the tasks in BCTasks are completed.

Following this definition, tasks are executed only when the precondition data are ready and the precondition tasks are completed. When the state of the task becomes executable, the workflow engine assigns the task to a service provider to execute it. When the service provider starts a service instance to execute the task, the task state becomes executing. If the execution is successful, the state of the task becomes completed; otherwise, the state of the task is failure. In the following subsection, we present detail scenarios on how the system composes and executes PLM-flow.

Assume that PLM-flow P=<T, AvailData> is selected, an executing scenario for P as follows:

1. Locating the executable tasks and starting the PLM-flow instance. At the start of execution, assume Ts is set of tasks in PLM-flow P that does not have any precursor tasks. Task t is an executable task if t ε Ts and t's precondition data is subset of AvailData. If for any task in Ts the required data is not in AvailData, the workflow engine needs to consult the data source rules to obtain the data. Each task in T(subscript: s) is then started.

2. Assigning the executable task to a service provider. When the workflow engine assigns a task to a service provider, it consults the business rules and generates an event table that maps the service provider's service schema to the events required by the workflow engine, where the entry is defined as <RuleID, Event>. During the execution of task, the service provider sends Event Notification to the workflow engine when any events in the event table occur.

3. Handling events. The execution of the PLM-flow is driven by events. During the execution of PLM-flow, when the workflow engine receives an event notification from a service provider, it uses the event to re-evaluate PLM-flow instance and to dynamically modify the PLM-flow as required. See the discussion above with respect to FIGS. 16A, 16B and 16C for a description of how workflows are modified.

4. The execution of PLM-flow is completed when the target task and all the forward-chain tasks are finished.

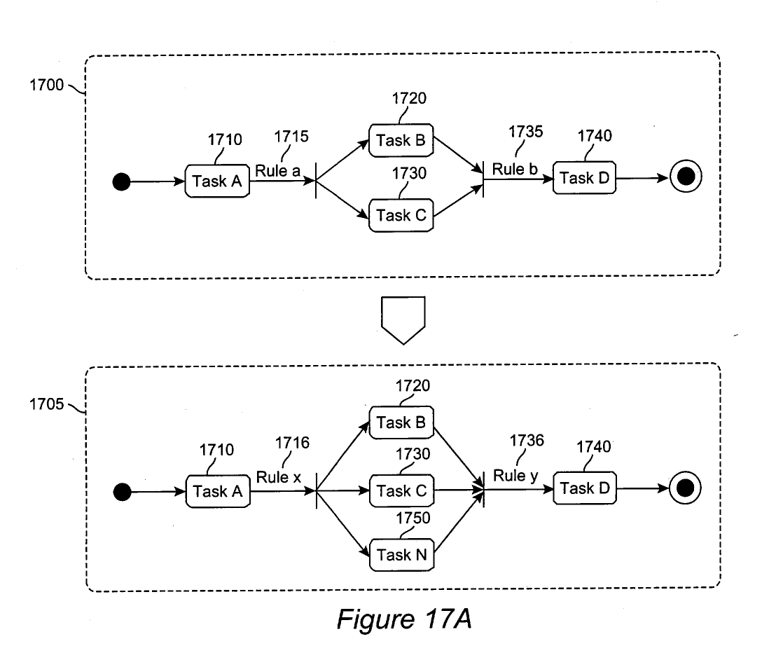

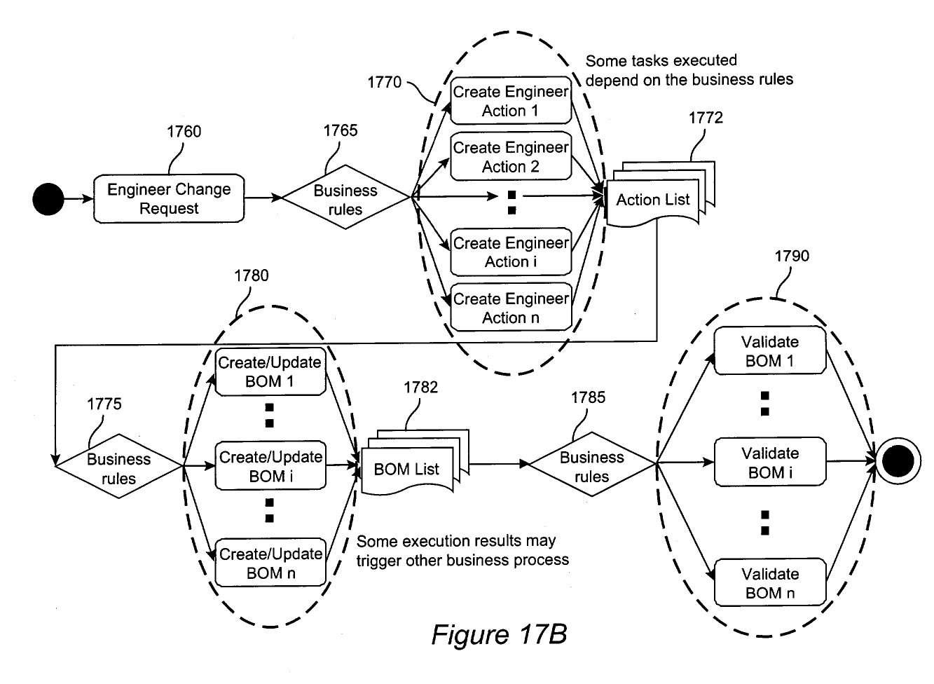

During the execution, the PLM-flow's target task becomes unreachable if there is a conflict among rules. There are two approaches to resolve conflicts: modify the rules or change PLM-flow schema. In the first approach, the system reports the conflicts and related rules to the user allowing the user to modify the rules or change the input data. The PLM-flow instance then resumes from the conflict point. In the second approach, the system automatically tries to find another PLM-flow schema that can avoid the conflict. In this approach, the system resolves the conflict by removing the sources of the conflict; the system selects an alternative PLM-flow schema that excludes the offending task. When a new PLM-flow schema is identified the system migrates the conflicted PLM-flow to the new PLM-flow schemas as illustrated in FIG. 17A. In pre-migration diagram 1700, Task A 1710 is connected to Task B 1720 and Task C 1730 by Rule a 1715, and Task D is connected to Task B 1720 and Task C 1730 by Rule b 1735. Diagram 1705 shows an alternative schema to which the system migrates, where a new Task N 1750 has been added between Task A 1710 and Task D 1740, and Rule a 1715 and Rule b 1735 have been replaced by Rule x 1716 and Rule y 1736. The need for this migration would have been identified at run time, when the workflow system determined that Task N is required to be performed. The workflow system then determined an appropriate time to halt the process to effect the migration, first validating the feasibility of the migration.

FIG. 17B presents an example of using rules to dynamically control workflow. The workflow control process is initiated by receipt of an Engineer Change Request 1760, which triggers application of business rules at block 1765. The business rules then operate to create engineer actions at 1770 that are collected in an action list 1772. These actions in turn trigger further application of business rules at block 1775. The business rules then operate to create or update bills of material at 1780 that are collected into a BOM list 1782. These actions trigger further application of business rules at block 1785 to validate the updated bills of material 1790.

### 4.0 Implementation and Embodiment

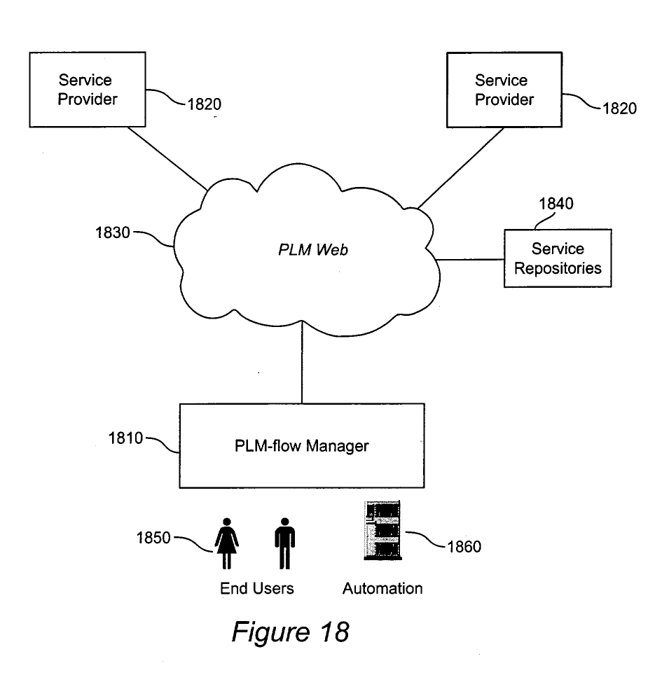

This section describes a logical system view of the PLM-web architecture. This implementation illustrates the key ideas behind the PLM-web concept presented above. This section identifies critical components and their relationships to one another and suggests a preferred embodiment. In its most rudimentary form, PLM system architecture consists of three basic components, identified in FIG. 18 as a PLM-flow Manager 1810, Service Providers 1820 and PLM-web 1830.

The PLM-flow Manager 1810 dynamically composes, selects, executes and monitors all aspects of ad-hoc workflow in accordance with the end user's intentions and directives. The PLM-flow manager 1810 interacts with service providers 1820 following the service composition schema published by the provider 1820 in a service repository 1840. In addition to supporting machine interfaces, the PLM-flow manger provides a graphic end user interface that presents to the end users 1850 system status, workflow state, and provides a facility for manually directed command and control. The PLM-flow Manager 1810 concurrently supports multiple ad-hoc workflow instances, treating each one distinctly and in isolation.

A service provider 1820 is a facility that provides a defined unit of work and subscribes to the service ontology and service description models previously presented. The concept of a service is a flexible abstraction: (1) services support an unrestricted scope of functions; (2) they may be located anywhere within the PLM-web; (3) they may be public or private and located internal or external to an enterprise. Examples of services are those that: provide engineering and scientific evaluation and computation; enable enterprise business processes; and support collaboration and inter-enterprise communication. PLM architecture provides a Business Process Proxy component, implemented on a service providers system, which enables an isolation and interaction layer between the public PLM-web and the private application services operating within the service provider domain.

The PLM-web 1830 is the virtual interconnection of PLM-flow managers 1810 and service providers 1820 based on the implementation of service ontology models and common interface standards. These models enable a common understanding of services and their interfaces, which facilitates event messaging and data exchange among PLM-flow managers 1810 and service providers 1820. Associated with the PLM-web is a Repository Service 1840 that contains service composition schema, a specification of service ontology, and a directory of services. This information is published by the service providers 1820 and is used by PLM-flow Manager 1810 to discover and interact with the service provider 1820.

The PLM-web 1830 need not be asymmetric, and it is noted that there is nothing in the architecture to preclude the concurrent operation of multiple PLM-flow Managers 1810 operating on many enterprises each interacting with service providers 1820 within the scope of the PLM-web 1830. As previously alluded to, both a PLM-flow manager 1810 and service provider 1820 components may concurrently operate within the same enterprise. Further, in a symmetric PLM-web, multiple Repository Services 1840 can coexist, both private and public, each dedicated to some instance of a PLM-web subset.

There are three types of logical repositories in the PLM-web. The first is a service ontology repository. A service ontology defines basic concepts and terminologies that are used inside a domain or industry (such as aerospace, electronic or steel manufacturing.) A service ontology provides a model for each service provider 1820 that subscribes to the class of ontology. Service ontology specifies such information as organization roles, operations, data variables, service quality criteria, etc. An enterprise or service provider that needs to discover what ontology they should use to conform to this repository.

The second type of repository is a service composition schema repository. For each service supported by a service provider 1820, the provider publishes a service composition schema that describes the public business process it supports, using a state machine or workflow model. (This is also known as microflow.) PLM-flow managers 1810 use this information to understand the workflow of the service provider and to dynamically construct ad-hoc workflow and event tables. The third type of repository is a service repository, which contains all the services supported by a service provider 1820, the service signatures and how to invoke them. PLM-flow managers use the service repository to find and bind to the service when performing dynamic service composition.

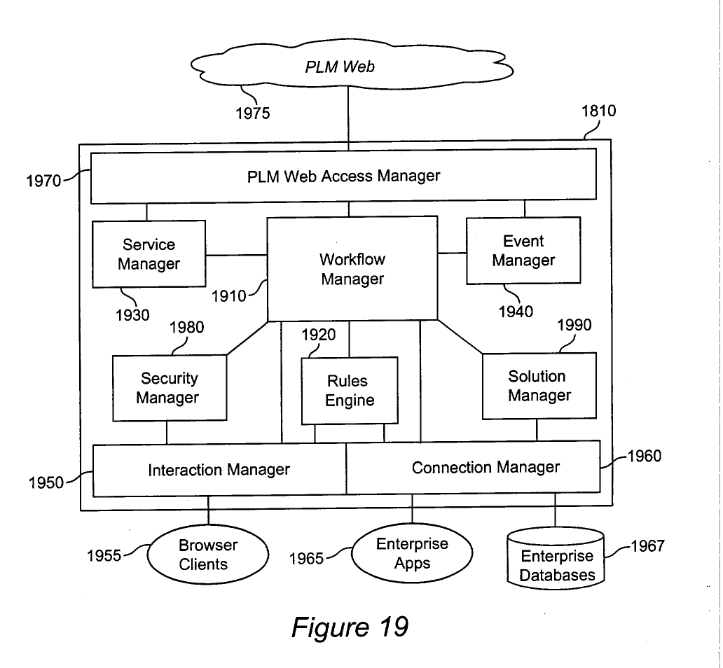

The PLM-flow Manager 1810 consists of modules that: (1) support work product analysis, service composition and workflow management; (2) basic components services such as authentication and serviceability; and (3) communication facilities that interact publicly through the PLM-web, or privately to systems that reside within the enterprise, as will be further described with reference to FIG. 19.

Central to the PLM-flow Manager is the workflow manager 1910. This component manages a PLM workflow instance from start through completion and provides the logic for state control, service collaboration monitoring, and in-context data reference and access. In an ad-hoc workflow paradigm, the workflow manager is enabled to dynamically modify workflow composition as a result of environmental changes, data modifications, and user and program events that occur within the life span of a PLM operation. The workflow manager maintains the state of the tasks comprising PLM workflow instance, which also includes the state of the microflow representing the service provider's workflow that it receives through event messages initiated by the provider. To accomplish these tasks the workflow manager 1910 directly depends on the rules engine 1920, service manager 1930, and event manager 1940 components.

The rules engine 1920 is both a repository of business rules and a set of programming logic that derives schemas and other actions based on event input, context, and the logical application of appropriate rules sets. Business processes can be expressed in business rules, which are statements that describe and control the processes, operations and strategies of how an enterprise conducts its business. For business integration and collaboration, business rules define the policies and procedures of inter and intra-enterprise interaction. In the context of business process template composition, business rules specify a wide range of knowledge and policy including, for example, those that: establish relationships and dependencies among tasks leading to the dynamic creation of business process templates, define service provider selection, enable coordination among tasks, and reference where data is located.

Information represented by business rules has traditionally been embedded in application code and database structures. The problem with this is:

It makes it difficult to modify business policies as this may result in code changes and application outages.

It is hard to understand the implementation and consequence of changing business rules.

It is not easy to understand the business process as represented by the aggregation of rules.

By separating rules from procedural code business policy is defined and managed as an independent entity. Further, rules are expressed non-programmatically, using descriptive terms that are more intuitive to the business manager as opposed to the application or code specific terms familiar to IT professionals. However, having made this separation, the introduction of a business rules management application, business rules repository and business rules engine become critical elements in the system. Business rules influence the entire end-to-end business process, spanning business process template composition and process re-evaluation during execution. The integration of business rules can support a wide range of functional elements within a system, including: business process templates (dynamic workflow), intelligent agents (directing value-add dynamic e-Business services), Web services (and other technologies facilitating application integration), and end-user interface (for end user personalization).

Effective use of this new business process technology requires that, as a first step, it support processes and models that are currently practiced; as a second and strategic step, the technology enhances existing business processes by enabling new functional capability that could not be reasonably supported by non-automated means. Supporting dynamic business process templates composition is such an example. It is observed that inter-company cooperative processes, with its requirement for collaborative e-Commerce among multiple trading partners, introduce an additional level of business process complexity that must be accounted for in an end-to-end process. Typically, an analysis of specific business scenarios results in a predefined business process template definition whose topology is represented within a static network of nodes (tasks) and arcs (transitions). Statically defined templates do not effectively support creative processes such as engineering design and project collaboration, where the business process is ad-hoc and cannot reasonably be codified in advance into a well-defined flow. Further, for businesses with complex processes involving a diverse and large number of tasks and objectives it is not feasible to define individual business process template to anticipate every variation. To better model a dynamic and complex real-time business environment, enterprises require a flexible means of composing business processes and modifying them based on real world events and evolving business rules.

Business rules may be expressed non-programmatically, using descriptive terms that are more intuitive to the business managers and subject matter experts. The rule engine may support several evaluative techniques: forward chaining (inference logic starting from a starting condition toward a goal), backward chaining (inference from a goal state back to a set of declared preconditions), and chains of simple or complex declarative rules where inference in not required. During a long running ad-hoc PLM process, the rules engine 1920 assists in: (1) recommending sequences of service compositions representing PLM objective; (2) generating workflow schemas based on established business rules, context, and other conditions; (3) searching for and advising alternatives among service providers during exploration phases; (4) assisting at decision checkpoints, recommending solutions based on business rules and historic behavior; (5) recommending participation, using internal and external business directories, during collaborative communication and approval and other business processes. To accomplish these objectives the rules engine 1920 is required to have access to data from both PLM-web 1830 and private enterprise repositories 1840. The PLM-web access manager module 1970 enables access to the PLM repository (not shown), which contains information on service providers and their service ontology and schema. The connection manager 1960 enables access to private enterprise repositories 1840 that contain such information as business contracts and contacts, historic process data, personnel roles and responsibilities. The interaction manager 1950 interacts with web browsers 1955 on the private enterprise.

The service manager 1930 has the capability of locating service providers and communicates with them through an event message model (not shown). The service manager 1930 performs several functions: (1) it interrogates the PLM-web repositories extracting the service provider schema that is subsequently evaluated by the rules engine 1920 and integrated into the workflow manager 1910; (2) it evaluates service compositions recommended by the rules engine, optimizing the selection based on an established user cost model and binds those service providers to tasks; and (3) it interacts with service providers on behalf of the workflow manager 1910, causing them to start, modify or end the processes as required. Table 4 presents some examples of generic quality criteria, associated with a user cost model, that are used to select service providers. Business processes are represented in standard format and passed to the workflow execution engine for execution.

TABLE 4
Generic Quality Criteria

| Criteria | Expression | Brief Explanation |
|---|---|---|
| Execution Cost | Qcost | Monetary cost of handling a request in US Dollars |
| Execution Time | Qdu | Execution time, measured in seconds |
| Availability | [symbol] av = Tr/(Tr + Td) | Tr is a service's available time in hour after the |
| | | service being created; Td is the service's |
| | | unavailable time in hour after the service being |
| | | created. |
| Reliability | Qre = Ns/Nr | Ns is the total times of successful response the |
| | | requests; Nr is total times of receiving requests. |
| Reputation | Qrep = Everage(Ri) | Ri is end user's ranking on a service's reputation |

The event manager 1940 handles the event notifications from the service provider. As events arrive, it knows how to process and route the message to the appropriate component in the PLM-flow manager. The event manager 1940 also issues events to service providers 1820, providing public control flow instructions and data. The security manager 1980 performs trust and access services that validate user authentication, authorization, accounting, based on permission and roles. Included in this may be user and service provider onboarding and registration. The security manager 1980 supports all interfaces including the browser interface and program-to-program interfaces. The solution manager 1990 provides the facilities for monitoring and managing the PLM-flow manager through audit logging, exception logging and tracing.

Three modules provide connectivity to the private internal enterprise (i.e. browser clients 1955, enterprise applications 1965, and enterprise databases 1967) and to the external PLM-web 1975. First, the interaction manager 1950 renders information to an end user interface, typically, to a web browser. Information is qualified by role and is based on the end user's authorization and the context of the PLM process. Further, the connection manager 1960 provides the necessary services and adapters to connect to and pass messages and data to applications, databases and other entities operating within the private enterprise. Finally, the PLM-web Access manager 1970 enables the necessary services to connect to and pass messages to service providers and other entities connected to the PLM-web 1975. Communications among these components are assumed to be in the form of XML documents transported across HTTP, JMS or other protocol.

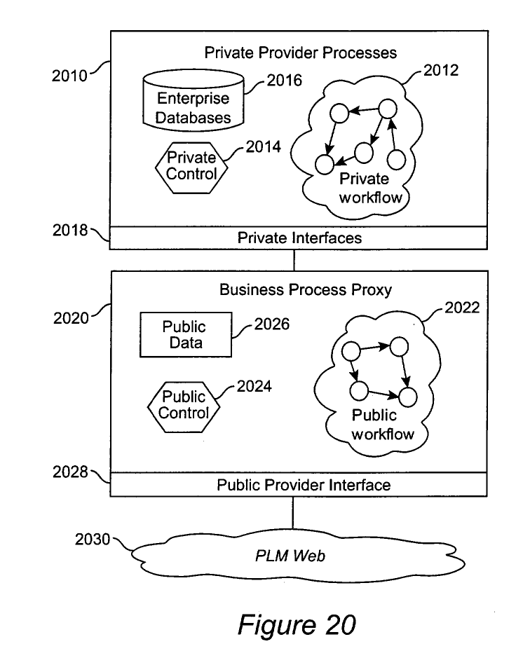

A service provider participating in the PLM-web is required to install a service adapter know as the Business Process Proxy that provides a mapping between their internal processes and public processes known to the PLM-web. This concept is illustrated in FIG. 20, where the private processes 2010 (comprised of private workflow 2012 and private controls 2014) and private data 2016 and private interfaces 2018 are hidden from the PLM-web 2030 through the use of the business process proxy 2020. The proxy exposes a public interface 2028 on behalf of the service provider that conforms to the established service ontology and service composition schema. A private to public mapping insures that only those workflow 2022, data 2026 and control processes 2024 are available to the PLM-web at large.

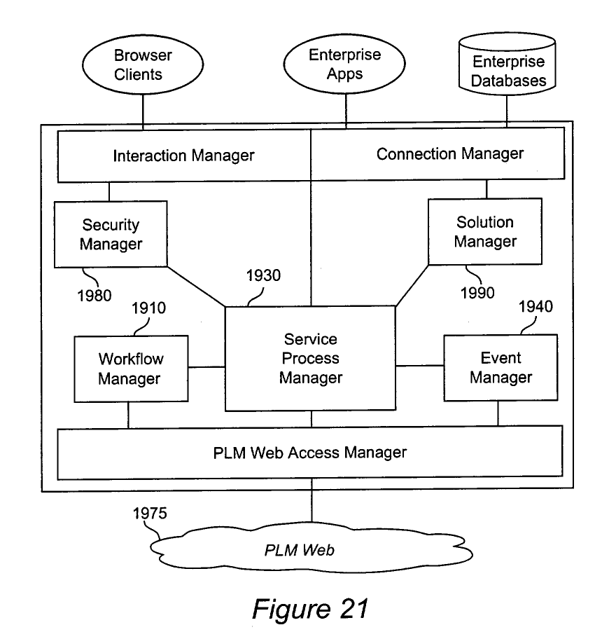

Once the business process proxy is established the service provider publishes their public process, based on service ontology and service composition schema, into the PLM repository that enables identification and service composition integration into the PLM workflow. Business process coordination is managed through a messaging event model. The business process proxy 2020 provides runtime support, service coordination and PLM-web communication. It has five major modules, namely, the process manager, an event manager, a business flow manager that manages the workflow, component and security managers, and several communication layers, as will be further described with reference to FIG. 21 as follows.

The service process manager 1930 is responsible for the overall coordination of business proxy tasks. It provides a mechanism to map the private service provider processes 2010 to a publicly defined workflow 2022 that is subsequently published and maintained in the PLM repository 1840. As events are received from the PLM-web 1975, or messages are received from private provider processes 2010, the service process manager 1930 coordinates with the Workflow manager 1910 to start, modify or terminate workflow instances, to maintain a coherent workflow state between the private 2012 and public 2022 processes, and to issue message events representing changes of state condition and data.

Working under the supervision of the service process manger 1930, the workflow manager 1910 maintains the tracking of tasks and state transitions associated with the microflow (provider workflow). As changes occur within a workflow instance the workflow manager 1910 initiates message events broadcast to the PLM-flow managers 1810 advising them of these conditions. The event manager 1940, security manager 1980, solution manager 1990 and communication layer components are essentially the same as described above in connection with the PLM-flow Manager in reference to FIG. 19).

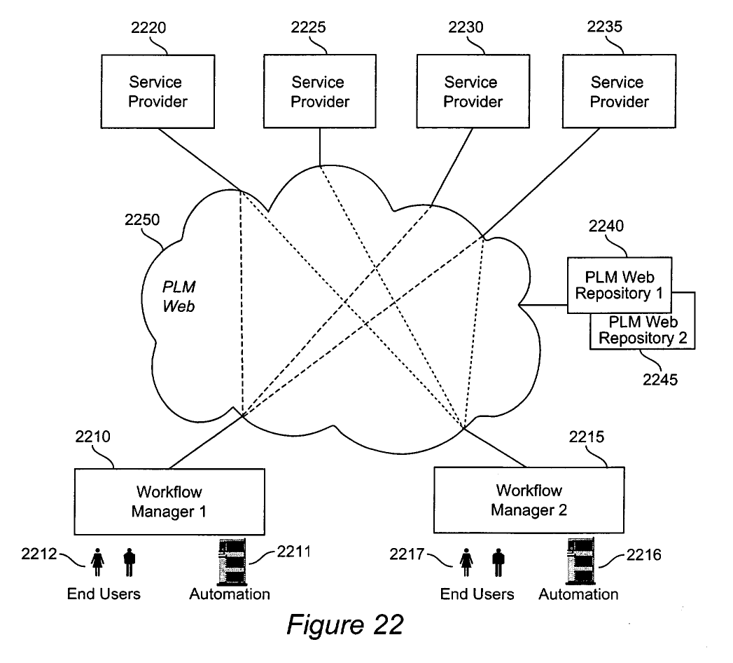

Turning now to FIG. 22, the PLM-web 2210 is a distributed network of PLM-flow managers 2220 and service providers 2230 specifically organized to meet PLM objectives. There are various architectural models that can support a PLM-web. These include a private web, a virtual private web, and a PLM Hub. A private web is dedicated to supporting a single enterprise and its approved set service providers. The management of this web is under the complete and exclusive control of the enterprise thus assuring total privacy and support of its operations. An example of a private web is illustrated in FIG. 18, where there is a single PLM-flow manager 1810, connected to an limited number of private service providers 1820, exclusively dedicated to the enterprise. In such a case the service repositories 1840, are also private and exclusive.

In a virtual private web, many enterprises and service providers are interconnected to the web and concurrently exploit the PLM-web, but because of enforcement of security and authorization across all components, each enterprise sees the PLM-web as their own virtually private web. This enables service providers to support many enterprises and presents a flexible and highly reconfigurable model. This is illustrated in FIG. 22 where two enterprises (represented by PLM-flow Workflow Manager 1 2210 implemented on System Automation 2211 and serving End Users 2212, and Workflow Manager 2 2215 implemented on System Automation 2216 and services End Users 2217) interact with different sets of service providers and repositories (2240 and 2245) over the same web 2250. Workflow Manager 1 uses Service Providers 2220, 2230 and 2235, and Workflow Manager 2 uses Service Providers 2220, 2225 and 2235.

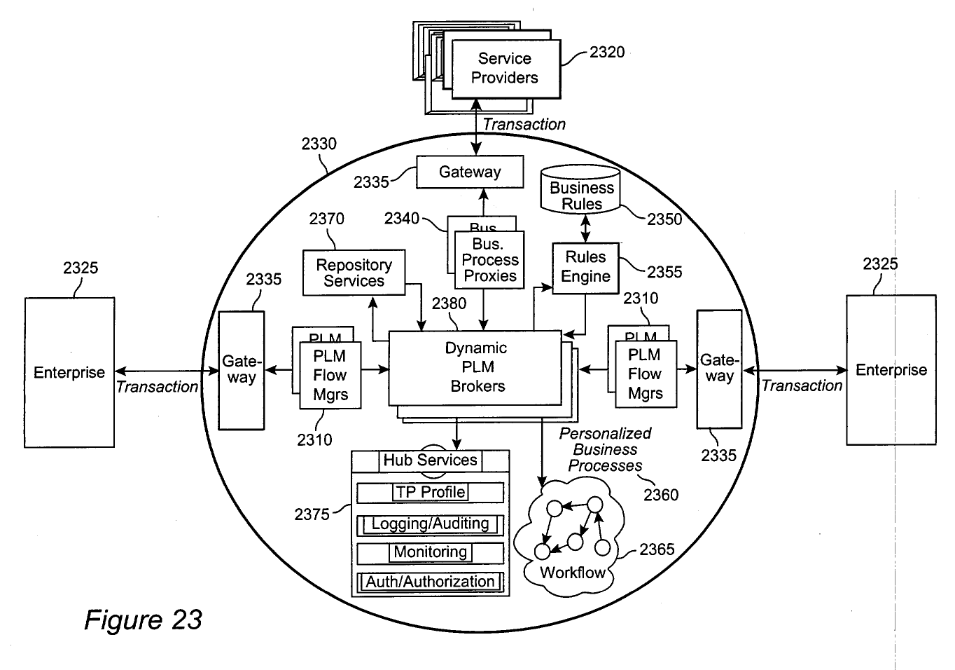

A PLM Hub is another model to support the realization of PLM-web, as illustrated in FIG. 23. In a hub the PLM-flow managers 2310 and the service manager business process proxies 2340 of the Service Providers 2320 are hosted within the application 2330 that enables the hub. Spokes of the hub are the Enterprises 2325 (serviced by the PLM-flow managers 2310) and Service Providers 2320 that use the hub 2330 via gateways 2235 and Dynamic PLM Brokers 2380 to access Repository Services 2370 and manage PLM processes, including service composition, authorization, flow management, interconnection, etc. The hub 2330 presents the PLM-web as a virtual private web. Since the majority of the PLM functions (e.g. hub services 2375 such as logging/auditing, monitoring, authorization) are hosted in the hub 2330 the cost of enabling PLM on an Enterprise 2325 or on a Service Provider 2320 are minimized. Furthermore, additional value added functions (such as advanced search, complex optimization, rule building, etc.) are easily implemented and deployed so that they can give benefit to all Enterprises 2325 and Service Providers 2320 that are connected to the hub 2330.

The challenge of PLM is to create tools that aid the user in their ad-hoc activities, while introducing an orderly set of processes and an organization around their work, in such a way as to promote creative activities, thus liberating users from the burden of managing the details of process and integration within a larger business context. The invention describes a methodology whereby a system, based on a user's declaration of a work objective request, uses business rules and a rules engine 2355 to compose business processes containing tasks, select service providers to execute the tasks, monitors the tasks and dynamically modifies the processes as the system is running.

Business rules 2350 are statements that describe and control the processes, operations and strategies of how an enterprise conducts it business. Business rules 2350 define or constrain some aspect of a business by asserting control over some behavior of that business. A business rule officiates over frequently changing business practices, and can come from within the company, or may be mandated by external sources. In the context of PLM, business rules 2350 can dynamically select appropriate project steps and make specific recommendations and guidance for business process composition and execution based on the project or step context. This context includes such variables as: the type of project task, specified business practices of the organization, an analysis of the history of actions from previous projects, and the predispositions of the specific user. Therefore, business rules 2350 encompass a wide range of knowledge: they can establish thresholds for administrative and workflow actions, define acceptable business practices, and set rules for configuration, customization and personalization of business processes 2355 described in a workflow 2360.

In a long running ad-hoc process, the rules engine 2355 assists in: 1) dynamically creating, monitoring and modifying the workflow process based on established business rules, context, and other conditions (see the discussion above in connection with FIG. 17B for a partial example); 2) searching for and advising alternatives among service providers, manufacturers atomic processes, etc., during exploration phases; 3) assisting at decision checkpoints, recommending best fit solutions based on business rules and historic behavior; and 4) recommending participation, using internal and external business directories, during collaborative communication and approval processes.

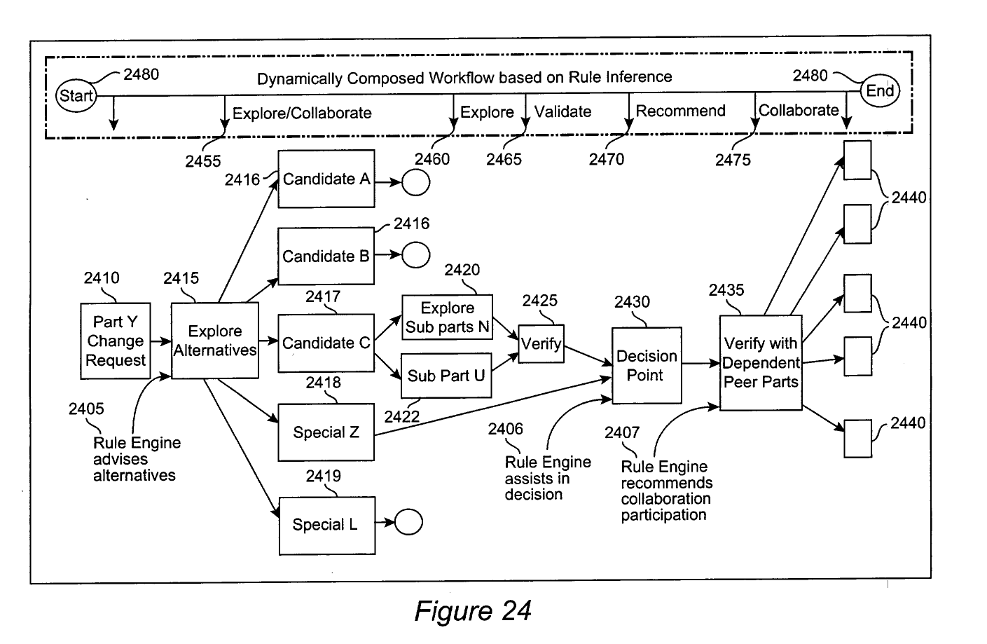

The role of business rules in driving a PLM workflow is illustrated in FIG. 24, which shows the role of a rule engine in response to a change request for a part Y 2410, from the outset 2450 to the end 2480 of the sequence. There is an exploration/collaboration phase 2455 in which alternatives are explored 2415, with advice from a rule engine 2405. A number of candidate alternatives 2416, 2417 are considered and relevant special factors 2418, 2419 are generated. A choice is then made, based upon an optimization of criteria. In the example shown in FIG. 24, Candidate C 2417 is selected and Candidates A and B 2416 are discarded. Candidate C 2417 is further explored 2416, generating sub-parts N 2420 and U 2422. In a validation phase 2465 these parts alternatives are verified 2425 for availability and suitability. Next, a decision point 2430 is reached where a recommendation 2470 must be made, and here a rule engine 2406 assists in making the decision. This is followed by a further recommendation of the rule engine 2407 to collaborate 2475 in verifying 2435 the chosen alternative with those participants 2440 providing dependent peer parts.

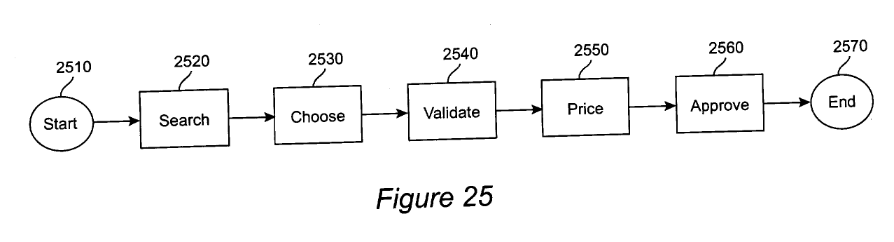

FIGS. 25, 26, and 27 illustrate the resulting flow of an ad-hoc workflow scenario, driven by business rules, which includes a dynamically generated user-to-user collaborative communication process. In this use case, the users declare their intent to perform a parts change process. Using business rules, an inferencing engine can deduce that for a parts change request a successful process workflow from start 2510 to finish 2570 can contain the following tasks: search 2520, choose 2530, validate 2540, price 2550 and approve 2560, as shown in FIG. 25.

However, the basic workflow does not describe all the possible tasks that may be required to be accomplished since this is directly dependent on runtime execution. For example, the consequence of validating a part is not known until the search is completed and a part is chosen. As a result the business rule inferencing engine may deduce a repetitive and recursive set of tasks (new part searches etc.) or introduce new tasks and services. This outcome is simply not known until the execution of the process—thus the workflow is ad-hoc.

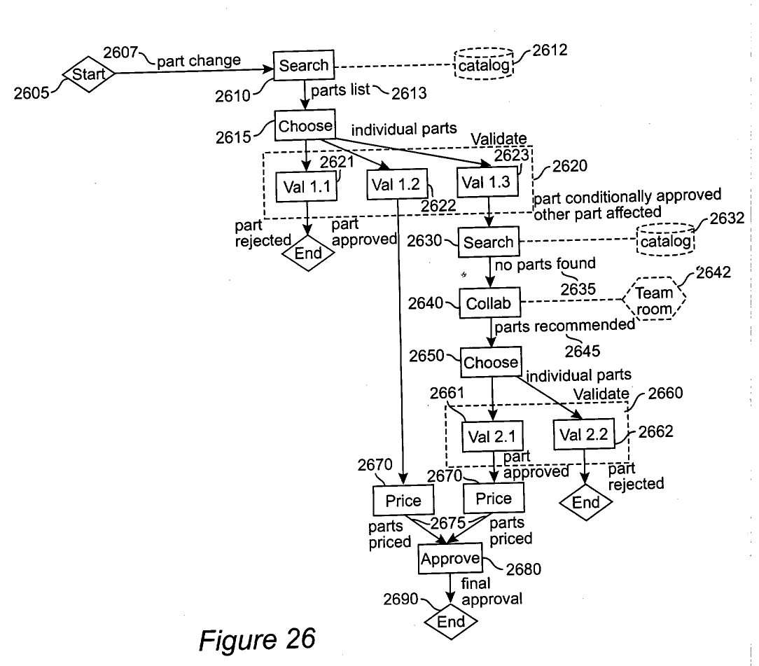

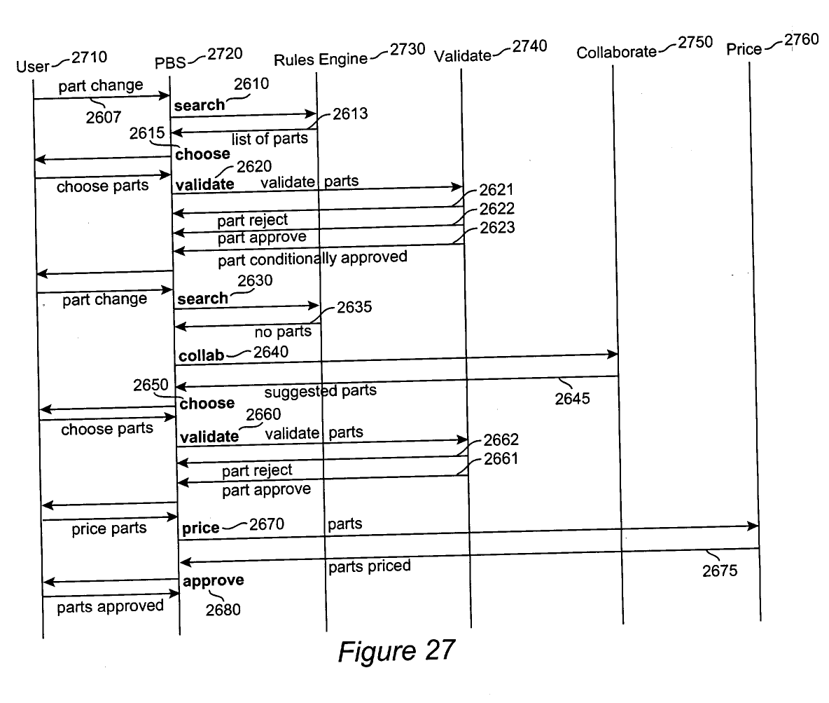

A specific example, presented in retrospect after the workflow has been completed, is illustrated in FIGS. 26 and 27.

1. The process is initiated 2605 with a parts change request 2607. Business rules help assist in the selection of potential replacement parts that the user may select, by requiring a search 2610 using a catalog 2612 and producing a parts list 2613 from which the user can choose 2615, with or without further assistance from the rules engine that implements the business rules.

2. After selection, the parts are validated 2620 using an external process that returns approval (as shown in the validation of part 1.2 2622), rejection (as shown in the validation of part 1.1 2621) or conditional approval with additional changes (as shown in the validation of part 1.3 2623). This process is recursive and may generate further search 2630 using a catalog 2632. If no parts are found, the rule engine may advise collaboration 2640 implemented using a virtual team room 2642, to recommend parts from which the user can again choose 2650. The parts choices are then validated 2660, resulting in approval, rejection or conditional approval pending further iteration of the process. At the end 2690 of the process the price 2670 of approved parts will be determined (2675) using a pricing service and finally approved by the user 2680, but there is no way to determine in advance how often conditional approval and further iteration of the process will occur or what results will be returned.

3. It is possible that the business rules are unable to make a part recommendation, as shown in FIG. 26 after search 2630. Should this be the case, a collaborative communication process may automatically be initiated by the rules engine, with an intelligent participant selection being made by a team 2642 involving only those subject matter experts that are appropriate to the process context. Through user-to-user collaboration (a new task 2640), parts are recommended. In an ideal implementation the new tasks are automatically added to the workflow.

The workflow process shown in FIG. 26 may also be described by a Design Flow Diagram as shown in FIG. 27, which illustrates event message communication between actors (automated tasks and users). The User 2710 communicates with the Business Process System 2720 to input parts change and choice decisions. The Rules Engine 2730 assists with searching and by generating tasks to perform validation 2740, collaboration 2750 and pricing 2760 functions.

PLM-web adopts a Web service model to provide dynamic business process composition and execution. Web services are self-contained, modular applications, based on open standards that enable program-to-program interaction. Using established standards and technologies, Web services provides applications with a framework for describing their services, publishing their services to a directory that advertises them, and a standardized means for binding service requesters to service providers. To address the objective of PLM, the preferred implementation of the invention uses a Web Services Model. (See http://www-3.ibm.com/software/solutions/webservices/for more information about what Web Services are how they are applied to support electronic commerce.) Thus the preferred embodiment is an apparatus and method of efficiently integrating business processes in a distributed environment using Web Services technology. In particular, in the context of the PLM-web, a Web service enables an ideal model for application integration between PLM-flow Manager and Service Providers. For most integration architectures—and Web Services are no different—Extensible Markup Language (XML), a subset of Standard Generalized Markup Language (SGML) promulgated by the International Standards Organization (ISO), plays a role in simplifying the exchange of business data among companies by providing a cross-platform approach in the areas of data encoding and data formatting. For example, Simple Object Access Protocol (SOAP), which is built on XML, defines a simple way to support Web Services by packaging information for exchange across system boundaries. Universal Description and Discovery Integration (UDDI) Registries, which describes Web Services and how to invoke them, support programmable XML elements to be placed in the Registries where others can access them remotely.

(1) PLM Repository. The basic concept of a PLM repository can be built using the UDDI directory feature. For PLM, the UDDI directory contains service descriptions, defined using WSDL, and includes information on the service and how to bind to it. In this context, PLM service providers are required to support a defined set of Web services that return service ontology and service schema composition, in addition to their specific service interfaces. For example, the PLM-flow Manager examines the UDDI directory for potential Service Providers, and using the ontology and service schema Web services, requests and receives specific information about the service from the Service Provider through its Web service.

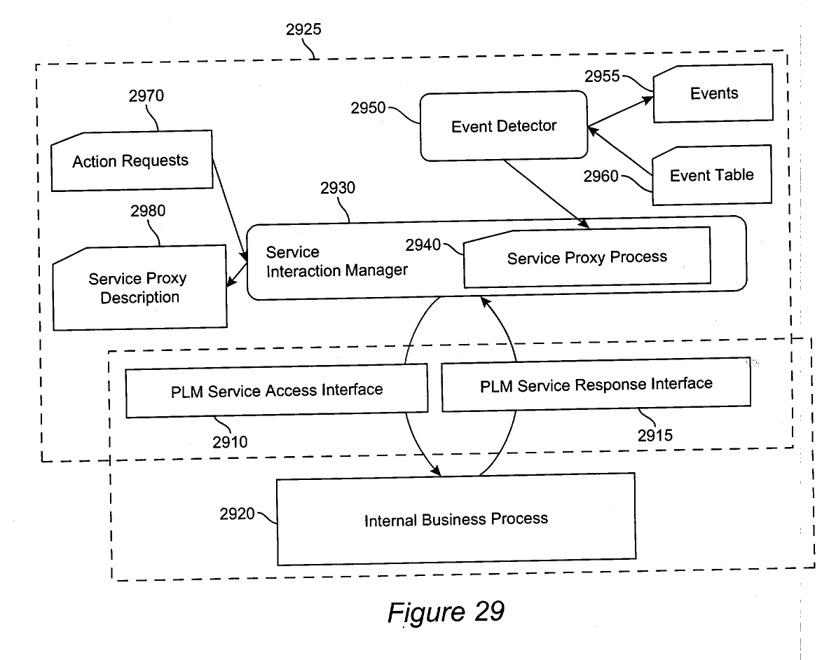

(2) PLM-web Interaction. PLM-web Access Components of the PLM-flow Manager and Business Process Proxy are deployed as a Web Service Access Interface (as shown by item 2910 in FIG. 29). This enables a standardized, flexible, platform independent, and easily reconfigurable program-to-program communication mechanism between PLM-flow Managers and Service Providers. Following this path to its ultimate realization, PLM ad-hoc workflow becomes a managed assemblage, or service composition, of Web Services.

(3) PLM Component Interaction. Modules within PLM-flow Manager and Business Process Proxy components can be implemented as Web Services distributed within the PLM-web. For example, the PLM-flow Manager can employ a rules engine Web service attached to the PLM-web but located outside the component. This enables the Flow Manager to customize the choice of services used based on the type of transaction, service and functional requirements, and business considerations. Further, off-loading services reduces the computing requirements of the PLM-flow Manager component. As with the description for PLM-web interaction, following this path to its ultimate realization, PLM component interaction becomes a managed assemblage, or service composition, of Web Services.

Business processes may be represented in various standard formats that are published by service providers or dynamically created by PLM-flow Managers and passed to the workflow execution engine for execution. The preferred standard format is Business Process Execution Language for Web Services (BPEL4WS), which provides a language for the formal specification of business processes and business interaction protocols (see Business Process Execution Language for Web Services, Version 1.0, Frank Leymann et.al., Satish Thatte, editor, 31 Jul. 2002, http://www.ibm.com/developerworks/library/ws-bpel/.)

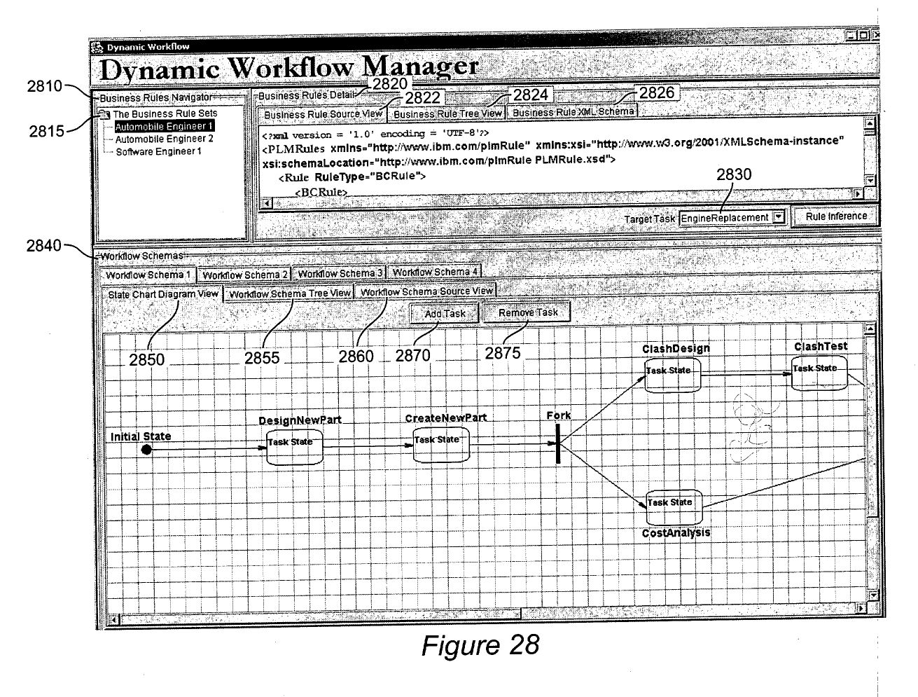

In a PLM framework a user interface is provided to perform several key functions. These include (1) providing a means to define, review and edit: business rules, tasks, candidate workflows; (2) reviewing the status of executing workflows; and (3) controlling executing workflows. FIG. 28 provides an illustration of a portion of the user interface used for the generation, modification and selection of workflow compositions. The interface contains the following elements:

A business rules navigator 2810 that presents all Rule Sets 2815 contained in the system. Each set contains the complete set of rules for a given project or business area. The user selects the appropriate rules set for their project.

A Business rules detail section 2820, which provides details of the business rules contained in the set, including (1) a source code view 2822; (2) a hierarchical tree view 2824; and (3) the defined Business Rules XML Schema reference 2826 that is used for creating rules.

A target task (end goal) drop down selection box 2830 that allows the user to specify the goal of the project.

A tab-based presentation of all workflow schemas 2840, along with a state diagram view 2850, workflow schema tree view 2855, and workflow schema source view 2860. Each tab-based workflow schema contains a different, yet valid workflow, ranked according to defined quality criteria.

The user may accept a candidate workflow schema, or modify a candidate schema by adding a task 2870 or removing a task 2875, adding or deleting relationships between tasks (not shown), or modifying task attributes (not shown) such as service provider. As a result of a modify workflow action, new business rules are automatically generated which represents the new workflow schema.

In the preferred embodiment, a PLM Web is realized through the implementation of components (PLM-flow Manager enabled on the enterprise driving PLM, and repository services) and methodologies (service ontologies, event messages, and workflow logic.) To establish a PLM-web several steps must first be accomplished. As a prerequisite the PLM-web supports two repository services:

Service repository, implemented as a Web Service Universal Description Discovery and Integration (UDDI) Repository. UDDI allows a service provider a way of describing their services (both function and binding information) and to publish their service to the UDDI directory that advertises them to service requesters.

Service ontology repository: A service ontology defines basic concepts and terminologies that are used inside a domain (such as aerospace, electronic or steel manufacturing.) A particular service ontology provides a model for each service provider that subscribes to that class of ontology.

In the preferred embodiment it noted that a service composition schema repository is not required, since service providers make this information available through the implementation of their own Web service.

To enable a PLM-flow Manager on the enterprise, the following must be provided:

1) A set of business rules for the enterprise. There are six kinds of business rules, namely user authorization rules, PLM-flow schema management rules, service provider selection rules, PLM-flow execution management rules service coordination rules and data source rules. These rules describe the entire behavior of PLM processes from an enterprise point of view.

2) An adaptation layer customization, integrating the PLM-flow Manager functional components to the enterprise system.

To enable a Business Process Proxy on the Service Provider the following must be completed:

1) Configuration and customization. The service provider must follow an established service ontology. An appropriate service ontology is selected from the service ontology repository. Then, following this ontology, the required services are enabled. Referring to FIG. 29, this may include customization of an adaptation layer (consisting of a PLM Service Access Interface 2910 and a PLM Service Response Interface 2915) to map the private functions and data contained in the internal business processes 2920 of the service provider to public processes 2925 made available by the service provider within the PLM-web. These include a Service Interaction Manager 2930 which manages each Service Proxy Process 2940 supported by an Event Detector 2950 which tracks Events 2955 and is governed by an Event Table 2960. The Service Action Manager 2930 responds to Action Requests 2970 and provides a Service Proxy Description 2980 which governs each Service Proxy Process 2940. Workflow made available to the PLM-web is described in the service composition schema and may be implemented as an Adaptive Document (ADOC) as described in ADoc-Oriented Programming, Prabir Nandi, et.al., The 2003 International Symposium on Applications and the Internet (SAINT'2003, Jan 27-31, 2003, Orlando, Fla., USA).

2) Publication of Web Service enabled services into the UDDI repository.

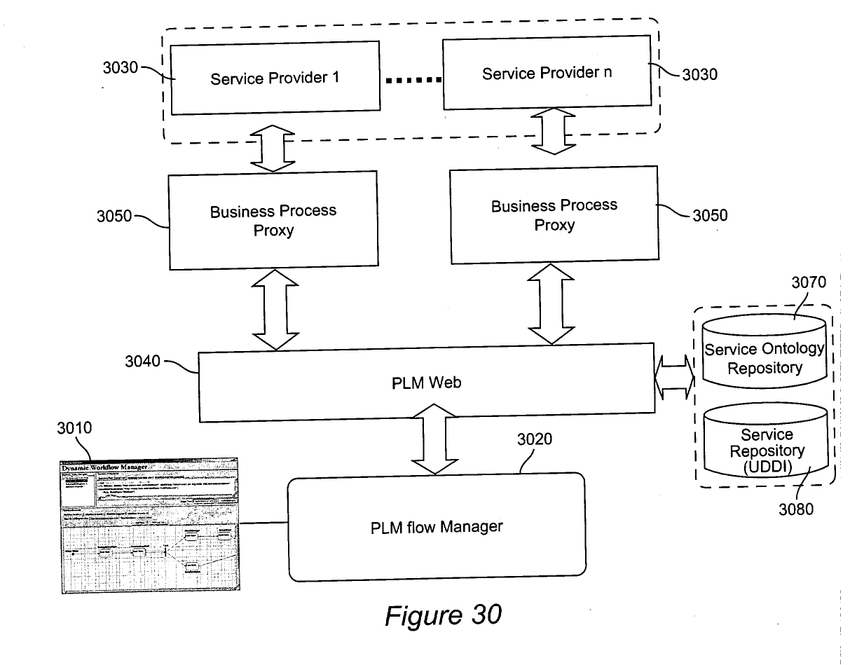

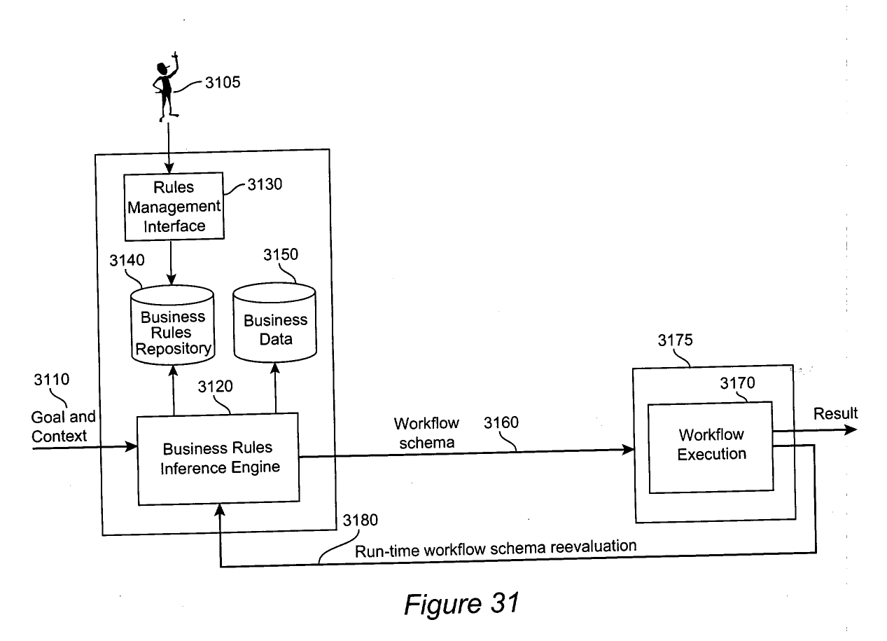

Referring to FIG. 30 and FIG. 31, when a user initiates a PLM request using the Workflow Manager interface 3010, the following steps are followed.

1. The business rules inferencing engine 3120 contained in the PLM-flow Manager 3020 is used to generate a predictive workflow using backward and forward chain algorithms. The predictive workflow enables the system to determine if a valid (non-conflicting) workflow path exists (indicated by the business rules) and to optimize the selection of an initial workflow (if multiple paths are generated).

2. When workflow is initiated (via user directed or programmatic means) the workflow engine assigns a task to a service provider using service provider selection rules. These rules take into account SLA and other business criteria to select a provider. Service providers who wish to compete in the selection process will use an ontology found in a Service Ontology Repository 3070 to generate entries for their services in a Service Repository 3080.

3. When a service provider 3030 is selected the PLM-flow manager 3020 generates an event table that is sent via PLM-web 3040 using a Business Process Proxy 3050 to the service provider 3030 along with service execution instructions. This event table specifies what events the PLM-flow manager 3020 is interested in following. The service provider 3030 sends event notifications via the Business Process Proxy 3050 when any event in an event table occurs during the execution of services.

4. Events are used as triggers to automate the business processes. Events can come from service providers, users, applications or the system. When the PLM-flow Manager 3020 receives an event it consults the business rules inferencing engine 3120 to re-evaluate the ongoing workflow and make dynamic modifications to it as required.

5. Ongoing progress of the PLM process is presented in a user interface 3010, along with status messages and other information. The interface provides a command and control facility to allow the user to direct workflow as required.

6. The PLM-flow Manager 3020 continues to monitor and dynamically compose services until the workflow has reached the user's intended goal, or until all services are completed and no more service composition can be performed.

This process may be summarized with reference to FIG. 31. User goals and context 3110 are provided to a Business Rules Inference Engine 3120. The Rules Inference Engine 3120 operates using business data 3150 and in accordance with business rules provided by enterprise users 3105 through a Rules Management Interface 3130 and stored in a Business Rules Repository 3140. Business processes represented by Workflow schema 3160 are generated by the Rules Inference Engine 3120, and then the workflow is executed 3170 in a run-time environment 3175. Operation of the Workflow Execution 3170 is monitored and used to reevaluate 3180 the business processes represented by the workflow schema 3160 in a feedback loop, which causes the Rules Inference Engine to regenerate the workflow scheme 3160. This process continues as long as results 3190 are being produced by Workflow Execution 3170.

While the invention has been described in terms of a preferred embodiment, those skilled in the art will recognize that the invention can be practiced with modification within the spirit and scope of the appended claims.

Having thus described our invention, what we claim as new and desire to secure by Letters Patent is as follows:

1. A system for supporting Product Lifecycle Management, comprising:
a distributed service network topology;
a hierarchy of functional domains connected within said topology, each domain having a service ontology and one or more service composition schemas defined by said service ontology, each service composition schema modeling a business process in said domain;
wherein descriptions of services provided to each domain is published to a service repository by providers of said services, said descriptions conforming to at least one of said service composition schemas;
a business process proxy for each said service description, said proxy encapsulating internal processes of the provider of said services;
an event messaging protocol enabling service collaboration and ad-hoc workflow composition, each said business process being implemented by an ad-hoc workflow comprised of one or more tasks connected by one or more business rules; and
for each said business process a business flow manager enabling dynamic composition of said ad-hoc workflow prior to execution and dynamic modification of said ad-hoc workflow as said business process executes, said business flow manager using a business rule inferencing framework for generating said ad-hoc workflows, said framework being able to stop execution of said workflow and regenerate said workflow in response to events distributed over said network topology using said messaging protocol, said framework also being able to detect conflicts in said workflows at composition time and at execution time.

2. The system of claim 1, wherein each said business flow manager further comprises:
a workflow engine that dynamically creates workflow schemas through a combination of backward-chain inference and forward-chain inference;
a workflow execution framework using rule inference that supports ad-hoc workflow through iterative analysis during execution time;
a business process model that allows dynamic modifications of business processes both at composition time and execution time; and
a set of business rule templates for creating business rules modeling business logic.

3. The system of claim 2, wherein a plurality of workflow schemas are created conforming to the business rules, and the dynamic workflow engine further comprises:
means for selecting one schema from said plurality based on a quality of service metric; and
means for starting the selected workflow schema and for triggering rule inference upon receipt of events from service providers.

4. The system of claim 2, wherein the set of business rule templates comprises:
user authorization rules giving the service schema that end users are authorized to use;
schema management rules used to dynamically create workflow schemas;
service provider selection rules that establish criteria and analytic function used in evaluating service providers;
execution management rules to control the execution of tasks;
service coordination rules for specifying the temporal connection among tasks being executed; and
data source rules for specifying how tasks are to obtain data.

5. The system of claim 3, wherein said business process model allows a user to change the selected schema by adding or deleting tasks or by adding or deleting transitions, the system then automatically generates additional business rules representing the user changes.

6. The system of claim 5, wherein said user changes are responsive to a conflict among business rules which causes the selected workflow schema to fail.

7. The system of claim 3, wherein the selected workflow schema fails in response to a conflict among business rules, the system then automatically generates an alternative workflow schema and migrates the selected workflow schema to the alternative workflow schema.

8. The system of claim 1, wherein said distributed service network topology is implemented using XML documents transported across HTTP.

9. The system of claim 8, wherein said distributed service network is implemented as a virtual private web.

10. A method for supporting Product Lifecycle Management, comprising the steps of:
determining one or more service ontologies, each said ontology belonging to a functional domain, said functional domains being organized in a hierarchy and connected over a distributed service network topology;
defining one or more service composition schemas from each said service ontology, each service composition schema modeling a business process in said service ontology's domain, wherein descriptions of services provided to each domain is published to a service repository by providers of said services, said descriptions conforming to at least one of said service composition schemas;
for each said service description, encapsulating in a business process proxy by said service provider of one or more internal processes of the service provider, said proxy providing public access to said internal processes;
using an event messaging protocol to enable service collaboration and ad-hoc workflow composition, each said business process being implemented by an ad-hoc workflow comprised of one or more tasks connected by one or more business rules;
using said service repository to identify service providers for said tasks; and
for each said business process, using a business flow manager to dynamically compose said ad-hoc workflow prior to execution and dynamically modify said ad-hoc workflow as said business process executes, said business flow manager using a business rule inferencing engine for generating said ad-hoc workflows, said framework being able to stop execution of said workflow and regenerate said workflow in response to events distributed over said network topology using said messaging protocol, said framework also being able to detect conflicts in said workflows at composition time and at execution time.

11. The method of claim 10, further comprising the steps of:
dynamically creating workflow schemas through a combination of backward-chain inference and forward-chain inference, and
iteratively analyzing workflow execution and regenerating said workflow schemas in response to said analysis,
wherein each said business flow manager further comprises:
a business process model that allows dynamic modifications of business processes both at composition time and execution time; and
a set of business rule templates for creating business rules modeling business logic.

12. The method of claim 11, wherein a plurality of workflow schemas are created conforming to the business rules, and further comprising the steps:
selecting one schema from said plurality based on a quality of service metric; and
starting the selected workflow schema and triggering rule inference upon receipt of events from service providers.

13. The method of claim 11, wherein the set of business rule templates comprises:
user authorization rules giving the service schema that end users are authorized to use;
schema management rules used to dynamically create workflow schemas;
service provider selection rules that establish criteria and analytic function used in evaluating service providers;
execution management rules to control the execution of tasks;
service coordination rules for specifying the temporal connection among tasks being executed; and
data source rules for specifying how tasks are to obtain data.

14. The method of claim 11, wherein said business process model allows a user to change the selected schema by adding or deleting tasks or by adding or deleting transitions, the business flow manager then automatically generating additional business rules representing the user changes.

15. The method of claim 14, wherein said user changes are responsive to a conflict among business rules which causes the selected workflow schema to fail.

16. The method of claim 12, wherein the selected workflow schema fails in response to a conflict among business rules, the business flow manager then automatically generating an alternative workflow schema and migrating the selected workflow schema to the alternative workflow schema.

17. The method of claim 10, wherein said distributed service network topology is implemented using XML documents transported across HTTP.

18. The method of claim 17, wherein said distributed service network is implemented as a virtual private web.

19. A computer readable medium containing code for supporting Product Lifecycle Management in a distributed environment, the code implementing the steps of:
determining one or more service ontologies, each said ontology belonging to a functional domain, said functional domains being organized in a hierarchy and connected over a distributed service network topology;
defining one or more service composition schemas from each said service ontology, each service composition schema modeling a business process in said service ontology's domain, wherein descriptions of services provided to each domain is published to a service repository by providers of said services, said descriptions conforming to at least one of said service composition schemas;
for each said service description, encapsulating in a business process proxy by said service provider of one or more internal processes of the service provider, said proxy providing public access to said internal processes;
using an event messaging protocol to enable service collaboration and ad-hoc workflow composition, each said business process being implemented by an ad-hoc workflow comprised of one or more tasks connected by one or more business rules;
using said service repository to identify service providers for said tasks; and
for each said business process, using a business flow manager to dynamically compose said ad-hoc workflow prior to execution and dynamically modify said ad-hoc workflow as said business process executes, said business flow manager using a business rule inferencing engine for generating said ad-hoc workflows, said framework being able to stop execution of said workflow and regenerate said workflow in response to events distributed over said network topology using said messaging protocol, said framework also being able to detect conflicts in said workflows at composition time and at execution time.
